(19) United States
(12) Patent Application Publication
(10) Pub. No.: US 2025/0384326 A1
(43) Pub. Date: Dec. 18, 2025

(54) MODULAR RYDBERG ARCHITECTURES FOR FAULT TOLERANT QUANTUM COMPUTING

(71) Applicants: President and Fellows of Harvard College, Cambridge, MA (US); Massachusetts Institute of Technology, Cambridge, MA (US)

(72) Inventors: Joshua Ramette, Cambridge, MA (US); Josiah Sinclair, Cambridge, MA (US); Viadan Vuletic, Cambridge, MA (US); Mikhail D. Lukin, Cambridge, MA (US); Dolev Bluvstein, Cambridge, MA (US)

(21) Appl. No.: 18/878,237

(22) PCT Filed: Jun. 30, 2023
(86) PCT No.: PCT/US23/26737

§ 371 Date: Dec. 23, 2024

Related U.S. Application Data
(60) Provisional application No. 63/357,882, filed on Jul. 1, 2022.

(51) Int. Cl. G06N 10/70; G06N 10/40

(52) U.S. Cl. CPC G06N 10/70; G06N 10/40

(57) ABSTRACT

Modular Rydberg architectures for fault tolerant quantum computing are provided. A first array and a second array of neutral atoms are provided. Each neutral atom has a first state and an excited Rydberg state. Each neutral atom is arranged to impose a Rydberg blockade on at least its nearest neighbors in its array when in the excited Rydberg state, thereby implementing a plurality of physical qubits. Each array comprises data qubits, and syndrome qubits. The syndrome qubits are configured to implement a quantum error correcting code with respect to the data qubits. Each array includes a subarray of communication qubits having a lower dimensionality than the array. Each communication qubit of the first subarray forms a Bell pair with one communication qubit of the second subarray. The first and second arrays of neutral atoms are configured to interact with each other only via the communication qubits.

### CROSS-REFERENCE TO RELATED APPLICATIONS

This application claims the benefit of U.S. Provisional Application No. 63/357,882, filed Jul. 1, 2022, which is hereby incorporated by reference in its entirety.

### STATEMENT REGARDING FEDERALLY SPONSORED RESEARCH OR DEVELOPMENT

This invention was made with government support under 1745303 awarded by National Science Foundation (NSF) and under DE-AC02-05CH11231 awarded by U.S. Department of Energy (DOE) and under W911NF2010021 awarded by U.S. Department of Defense/Defense Advanced Research Projects Agency (DOD/DARPA). The government has certain rights in this invention.

### BACKGROUND

Embodiments of the present disclosure relate to systems for neutral atom based quantum computation, and more specifically, to modular Rydberg architectures for fault tolerant quantum computing.

### BRIEF SUMMARY

According to embodiments of the present disclosure, quantum computing systems are provided. The system comprises: a first array and a second array of neutral atoms, each array having a first dimensionality; each neutral atom having a first state and an excited Rydberg state, each neutral atom arranged to impose a Rydberg blockade on at least its nearest neighbors in its array when in the excited Rydberg state, thereby implementing a plurality of physical qubits; wherein each array comprises a plurality of data qubits, and a plurality of syndrome qubits, wherein, for each array, the plurality of syndrome qubits is configured to implement a quantum error correcting code (e.g., stabilizer code) with respect to the data qubits. The first array of neutral atoms comprises a first subarray of communication qubits, and the second array of neutral atoms comprises a second subarray of communication qubits, the first and second subarrays having a second dimensionality that is lower than the first dimensionality; each communication qubit of the first subarray array forming a Bell pair with one communication qubit of the second subarray; the first and second arrays of neutral atoms are configured to interact with each other only via the communication qubits.

According to embodiments of the present disclosure, methods of carrying out a logical operation between logical qubits are provided. The method comprises: providing a quantum computing system as described above and carrying out a logical operation between at least one data qubit of the first array and at least one data qubit of the second array.

According to embodiments of the present disclosure, methods of extending a quantum error correcting code (e.g., stabilizer code) across two non-interacting arrays of particles are provided. The method comprises: providing a quantum computing system as described above and extending the quantum error correcting code (e.g., stabilizer code) across the first and second arrays.

### BRIEF DESCRIPTION OF THE SEVERAL VIEWS OF THE DRAWINGS

FIG. 1 is a schematic view of two surface code patches according to embodiments of the present disclosure.

FIG. 2 is an exemplary teleported CNOT circuit according to embodiments of the present disclosure.

FIG. 3 is a graph of logical error rate for exemplary repetition and surface codes.

FIG. 4 is a graph of CNOT and Bell pair error rates in exemplary embodiments of the present disclosure.

FIG. 5 is a schematic view of a system for quantum computation according to embodiments of the present disclosure.

FIG. 6 is a schematic view of an exemplary cavity configuration according to embodiments of the present disclosure.

FIG. 7 is a flowchart illustrating a method of collective measurement according to embodiments of the present disclosure.

FIG. 8 is an energy level diagram according to embodiments of the present disclosure.

FIGS. 9A-D are schematic views of an exemplary cavity, illustrating a binary search according to embodiments of the present disclosure.

FIG. 10 is a schematic view of the apparatus of FIG. 5, using free space entanglement according to embodiments of the present disclosure.

FIG. 11 is a schematic view of the apparatus of FIG. 5, using cavity entanglement according to embodiments of the present disclosure.

FIGS. 12A-C are schematic views of a surface code with a seam, illustrating the limited extent of error according to embodiments of the present disclosure.

FIG. 13 is a graph of logical error rate for exemplary noisy syndrome surface and repetition codes.

FIG. 14 is a graph of logical error rate for an exemplary code with and without a seam according to embodiments of the present disclosure.

FIG. 15 is a table of terms used herein.

FIG. 16 is a schematic view of an exemplary matching lattice according to embodiments of the present disclosure.

FIGS. 17A-C are graphs illustrating analytical logical failure bounds according to embodiments of the present disclosure.

FIGS. 17D-F are graphs illustrating numerical simulations of failure bounds according to embodiments of the present disclosure.

FIG. 18 is a graph illustrating threshold sag in configurations having multiple seams according to embodiments of the present disclosure.

FIG. 19 is a table of phenomenological bit flip error probabilities according to embodiments of the present disclosure.

FIG. 20 is a schematic view of an apparatus for quantum computation according to embodiments of the present disclosure.

FIG. 21 depicts a classical computing node according to an embodiment of the present disclosure.

### DETAILED DESCRIPTION

A quantum bit (qubit) is the fundamental building block for a quantum computer. By analogy to classical bits which are used to store information in traditional computers (each bit is 0 or 1), qubits can occupy two distinct states labeled |0 [symbol] and |1 [symbol] , or any quantum superposition of the two states. In various applications, multiple qubits are entangled in order to build multi-qubit quantum gates.

Bits and qubits are each encoded in the state of real physical systems. For example, a classical bit (0 or 1) may be encoded in whether a capacitor is charged or discharged, or whether a switch is ‘on’ or ‘off’. Quantum bits are encoded in quantum systems with two (or more) distinct quantum states. There are many physical realizations that may be employed. One example is based on individual particles such as atoms, ions, or molecules which are isolated in vacuum. These isolated atoms, ions, and molecules have many distinct quantum states that correspond to different orientations of electron spins, nuclear spins, electron orbits, and molecular rotations/vibrations.

In principle, a qubit may be encoded in any pair of quantum states of the atom/ion/molecule. In practice, a key parameter of qubits is described by their quantum coherence properties. Coherence measures the lifetime of the qubit before its information is lost. It has a close analogy with classical bits: if a classical bit is prepared in the 0 state, then after some time it may randomly be flipped to 1 due to environmental noise. Quantum mechanically, the same error may occur: |0 [symbol] may randomly flip to |1 [symbol] after some characteristic timescale. However, qubits may suffer from additional errors: for example, a superposition state

$$\frac{( \vert 0 + \vert 1 )}{\sqrt{2}}$$

may randomly flip to

$$\frac{( \vert 1 - \vert 0 )}{\sqrt{2}} .$$

In real quantum computers, the qubits must be encoded in quantum states which have long coherence properties.

Quantum computers generally can contain many qubits, each encoded in its own atom, molecule, ion, etc. Beyond simply containing the qubits, the quantum computer should be able to (1) initialize the qubits, (2) manipulate the state of the qubits in a controlled way, and (3) read out the final states of the qubits. When it comes to manipulation of the qubits, this is usually broken down into two types: one type of qubit manipulation is a so-called single-qubit gate, which means an operation that is applied individually to a qubit. This may, for example, flip the state of the qubit from |0 [symbol] to |1≣, or it may take |0≣ to a superposition state

$$\frac{( \vert 0 + \vert 1 )}{\sqrt{2}} .$$

The second necessary type of qubit manipulation is a multi-qubit gate, which acts collectively on two or more qubits, including those that are entangled. A multi-qubit gate is realized through some form of interaction between the qubits. The various quantum computing platforms (having various physical encodings of qubits) rely on different physical mechanisms both for single-qubit gates as well as multi-qubit gates according to the physical system that is storing the qubit.

In various embodiments of a quantum computer, a qubit is encoded in two near-ground-state energy levels of an atom, ion, or molecule. An example of this is a hyperfine qubit. Such a qubit is encoded in two electronic ground states that differ by the relative orientation of the nuclear spin with respect to the outer electron spin. Pairs of such states can be chosen so that they are particularly robust/insensitive to environmental perturbations, leading to long coherence times. These states are split in energy by the hyperfine interaction energy of the atom/ion/molecule, which is the interaction energy between the nuclear spin and the electron spin. The robustness of the qubit can be understood as the energy splitting between the two states being particularly stable. For this reason, such states are called clock states because the stable energy splitting can form an excellent frequency-reference and as such forms the basis for atomic clocks. Typical hyperfine splitting between these qubit states is in the 1-13 GHz frequency range.

To perform single-qubit gates on such a hyperfine qubit, it is possible to apply coherent microwave radiation at the exact frequency of the energy splitting between states. However, there are two drawbacks to this approach. First, microwaves cannot be applied to just one qubit without affecting adjacent qubits. This is because qubits are encoded in particles that are typically just a few microns apart from one another, and microwaves cannot be focused to such a small scale due to their large wavelength. Second, the microwave intensity is fairly limited and as such the maximum speed of single-qubit gates is correspondingly limited.

An alternative approach is based on stimulated Raman transitions. In this case, a laser field is applied to the atoms/ions/molecules. The laser field is nearly (but not exactly) resonant with an optical transition from one of the ground states to an optically excited state. The laser contains multiple frequency components separated in frequency by exactly the amount equal to the hyperfine splitting of the qubit. The atom/ion/molecule can absorb a photon from one frequency component and coherently emit into a different frequency component, and in doing so it changes its state. This approach benefits from the capability of focusing the laser field onto individual particles or subsets of particles in the quantum computer. The laser field can also be applied with high intensity, allowing much faster gate operations.

Neutral atom quantum computers encode qubits in individual neutral atoms. The neutral atoms are trapped in a vacuum chamber and levitated by trapping lasers. Most commonly, the trapping lasers are individual optical tweezers, which are individual tightly focused laser beams that trap an individual atom at the focus. Alternatively, individual atoms may be trapped in an optical lattice, which is formed from standing waves of laser light which produces a periodic structure of nodes/antinodes.

A typical approach for encoding a qubit in neutral atoms is the hyperfine qubit approach, in which two ground states split by several GHz form the qubit. Multi-qubit gates in neutral atom quantum computers are realized using a third atomic state, which is a highly-excited Rydberg state. When one atom is excited to a Rydberg state, neighboring atoms are prevented from being excited to the Rydberg state. This conditional behavior forms the basis for multi-qubit gates, such as a controlled-NOT gate. The Rydberg state is used temporarily to mediate the multi-qubit gate, and then the atoms are returned back from the Rydberg state to the ground state levels to preserve their coherence.

Trapped ion quantum computers use atomic species that are ionized, meaning they have a net charge. In most cases, many ions are trapped in one large trapping potential formed by electrodes in a vacuum chamber. The ions are pulled to the minimum of the trapping potential, but inter-ion Coulomb repulsion causes them to form a crystal structure centered in the middle of the trapping potential. Most commonly, the ions arrange into a linear chain. Other ways to trap ions are also possible, such as using optical tweezers, or trapping ions individually with local electric fields with a more complex on-chip electrode structure.

Qubits are encoded in trapped ions in multiple ways. One common approach is to use ground-state hyperfine levels, as described for neutral atoms. In trapped ions with hyperfine-qubit encoding, as with neutral atoms, single-qubit gates may use microwave radiation or stimulated Raman transitions.

Unlike in neutral atoms, trapped ion hyperfine qubits rely heavily on stimulated Raman transitions for performing multi-qubit gates. Stimulated Raman transitions may be used to control both the hyperfine state of the ion and also to change the motional state of the ion (i.e., add momentum). This can be understood as absorbing a photon moving in one direction and emitting a photon in a different direction, such that the difference in photon momentum is absorbed by the ion. Since many ions are often trapped in one collective trapping potential and are mutually repelling one another, changing the motional state of one ion affects other ions in the system, and this mechanism forms the basis for multi-qubit gates.

According to various embodiments of a quantum computer, individual particles (atoms/ions/molecules) can first be trapped in an array and arranged into particular configurations. Next, one or more particles are prepared in a desired quantum state. Quantum circuits can then be implemented by a sequence of qubit operations acting on individual qubits (single-qubit gates) or on groups of two or more qubits (multi-qubit gates). Finally, the state of the particles can be read out in order to observe the result of the quantum circuit. The readout can be accomplished using an observation system that typically includes an electron-multiplied CCD (EMCCD) camera image to detect particles' loaded positions, and a second camera image to read out the particles' final states by, for example, detecting fluorescence emitted by the particles in their final states.

Rydberg atom arrays have favorable scaling properties (a 256 qubit simulator has already been realized), long qubit coherence times (hyperfine qubits with coherence time greater than one second have been experimentally demonstrated using dynamical decoupling methods), and gate speeds exceeding 1 MHz. Single-qubit gates can reach 0.02% error rates, and two-qubit gates have reached fidelities of >97% in rubidium and 99.1% in strontium. Furthermore, in both cases, detailed error budgets provide a clear path for further improvements and are backed up by theoretical limits of 99.9%. Moreover, as Rydberg gate fidelity is only dependent on system size through available laser power, this fidelity is not expected to degrade as systems scale. Fast transport of atoms has also been realized, endowing atom arrays with re-configurability on 100 microsecond time scales, enabling nonlocal gates as well as qubit transport between dedicated zones within a multi-functional quantum processor.

To address the occurrence of errors such as those described above, various quantum error correcting codes may be employed. Quantum error-correcting codes restore a noisy, decohered quantum state to a pure quantum state. A stabilizer quantum error-correcting code appends ancilla qubits to qubits that are being protected. A unitary encoding circuit rotates the global state into a subspace of a larger Hilbert space. This highly entangled, encoded state corrects for local noisy errors.

One class of stabilizer codes known in the art is the surface codes. One such surface code is a low-density parity-check (LDPC) code with a favorable threshold of about 3%. Data qubits are laid out on the edges of a square lattice (dots) while measure X and measure Z syndrome qubits check for bit and phase-flip errors, respectively, on neighboring data qubits.

Quantum computers made from noisy components require error correction (QEC) to scale. For a given QEC code to suppress errors, components must introduce noise below (ideally about 10× below) a code-dependent threshold—errors must be removed faster than they accumulate. While many different QEC codes are currently being investigated, to date, surface codes have the highest thresholds, tolerating approximately 1% errors from circuit level components. This leads to a target of 0.1% total circuit level errors (including gate and memory errors) per code cycle for quantum hardware.

A fault-tolerant quantum computer capable of executing Shor's algorithm for a 2000 bit number will require thousands of logical qubits, and tens of trillions of logical operations, with quantum error correction imposing large overheads of tens to thousands of physical qubits per logical qubit. It is not practical to implement such a large number of logical qubits in a single device due to engineering constraints. Trapped ion systems experience serious gate fidelity degradation for system sizes larger than a few tens of qubits. Superconducting systems are limited to a few thousand qubits by the size and performance of dilution refrigerators. Rydberg arrays are the most scalable, but are not expected to surpass system sizes of ten thousand qubits. In addition to the above-mentioned limitations, any platform will likely have some maximum size beyond which it becomes unwieldy to control all of the qubits at once in the same module (e.g., only so many ions can fit per chain, only so many Rydberg atoms fit in a vacuum chamber).

To address these challenges, the present disclosure provides a scalable, modular, fault-tolerant architecture for quantum computing based on Rydberg arrays. For example, approximately 50 Rydberg array modules each containing 10⁴ qubits can be connected to realize a quantum computer with half a million qubits.

While alternative modular architectures focus on very small modules containing 2-5 qubits, architectures provided herein consist of large modules containing thousands of physical qubits, which form surface code patches that are linked together by optical cavity photonic interconnects. While the low fidelity of Bell pairs generated via photonic interconnects is a major challenge for alternative modular architectures, the approaches provided herein are uniquely immune to Bell pair infidelity because communication errors only occur along one edge of the code.

Numerical simulations indicate a threshold for communication errors of about 10%. Moreover, because no distillation is required, local gate requirements remain around 1%. These relaxed communication requirements enable the fault-tolerant connection of currently available Rydberg arrays of many atoms using only modest quality Bell pairs. Quantitative performance estimates are provided, showing that a single optical cavity of modest quality allows Bell pair distribution fast enough to realize 10 kHz surface code cycles—much faster than current coherence times (which surpass one second)—as well as faster syndrome readout and atom reloading.

In summary, Rydberg arrays have demonstrated the coherence times, gate speeds, and the anticipated gate fidelities required to continuously operate a surface code patch (meeting the 0.1% per code cycle benchmark). Once a surface code can be realized on a single Rydberg array, it will ultimately be limited by the size of the array. Estimates of the maximum size constraints for arrays vary, but laser power, field of view, and the bandwidth of acousto-optical deflectors all point towards an upper bound of approximately 10,000 qubits. Regardless of the exact number of atoms that can be locally controlled, at some point scaling requires linking up multiple arrays. Scalability is provided in the present disclosure by providing a unit module equipped with sufficient quantum input/output (I/O), such that the system can be scaled up arbitrarily by simply adding on more modules. In various embodiments, optical interconnects are used for quantum I/O, where entanglement distribution enables teleported gates for inter-module operations.

A major challenge for all distributed architectures is that each teleported gate uses a nonlocally generated Bell pair (generally of lower fidelity due to the additional complexity of communicating between distinct modules) and several local operations, which, when combined, make the Bell pair have a much lower fidelity than the local operations themselves. One solution is to distill many Bell pairs into a few higher fidelity Bell pairs. Even more significant than the extra time and space overheads required for this distillation, is the fact that distillation itself requires ˜10 local operations, meaning that the local operations then need to be ˜10× below the code threshold in order for the teleported gate itself to reach the code threshold. Because of this, in alternative modular architectures, thresholds for local operations are ˜10× more stringent than what would be required for a single large module because of the high number of local operations required in these distillation and teleported gate protocols.

The present disclosure shows that using large modules enables fault tolerant logical gates between modules based on noisy shared Bell pairs, with minimally increased requirements for local operations. This allows one to take large code patches operating at or below threshold, and connect them with noisy Bell pairs into a larger error correcting code without increased requirements on the local gates. While much higher fidelity local operations appear necessary for small modules where teleported gates are the primitive operations at the code level, for large modules, protocols are provided where gate teleportation only occurs on lower dimensional boundaries between modules. The present disclosure provides heuristic arguments backed up by numerical simulations to show that the threshold requirements for the local gates are almost unaffected, even when noisy Bell pairs and teleported gates are used to connect distinct modules.

Accordingly, Rydberg arrays augmented with sufficiently fast production of noisy inter-module Bell pairs form unit modules which can be connected together to form a truly scalable, fault-tolerant quantum computer.

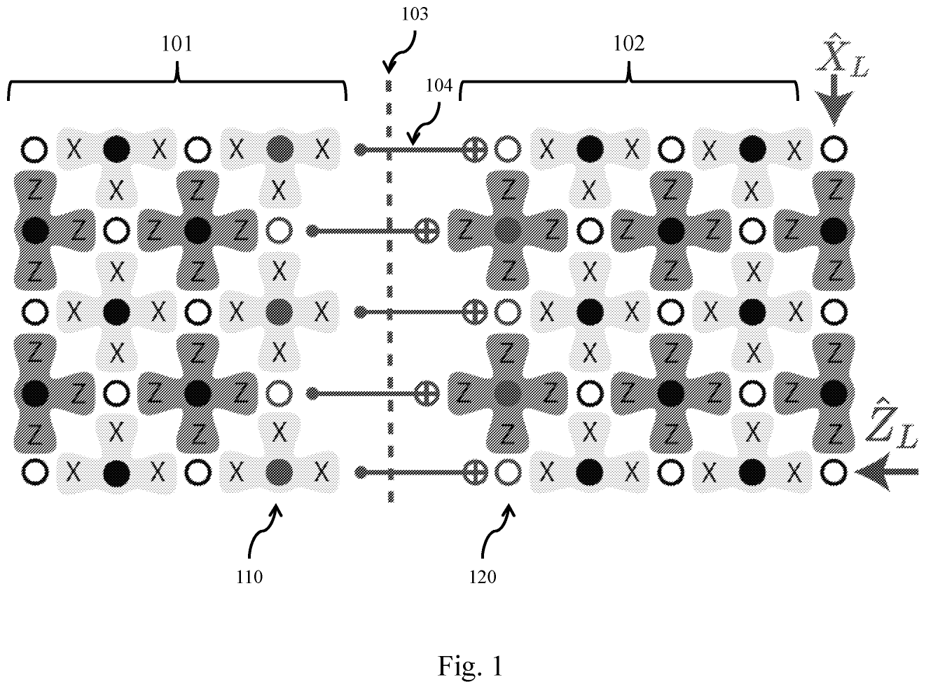

With reference to FIG. 1, two surface code patches 101, 102 in separate modules are connected along a lower dimensional seam 103. Stabilizer checks spanning the seam are carried out using teleported gates 104 (where a connected dot and a crossed circle indicate an entangled pair). Data qubits are indicated by open circles, while syndrome qubits are indicated by solid circles. The data and syndrome qubits in columns 110 and 120, which are depicted in gray and make up a small fraction of total qubits, experience elevated noise levels due to the lower fidelity of intermodule operations. X_{L}, Z_{L} indicate logical string operators.

As shown in FIG. 1, connecting multiple modules fault-tolerantly requires that code patches be linked only along one edge. To compute across modules fault tolerantly, a code patch is initialized and maintained straddling the seam. The seam interface region of local code patches has a lower dimension than the bulk. A lower dimensionality corresponds to lower entropy, which leads to a higher threshold.

The seam and bulk both contribute to the logical errors, as given in Equation 1. A larger

$${p}_{th}^{seam}$$

may permit a larger p^{seam}.

$${P}_{fail} ∼ {( \frac{{p}^{bulk}}{{p}_{th}^{bulk}} )}^{\frac{d}{2}} + {( \frac{{p}^{seam}}{{p}_{th}^{seam}} )}^{d / 2} \qquad Equation 1$$

Given an error model based on Rydberg error rates, a bulk threshold of about 1% is found. For comparison, a noisy syndrome repetition code has a threshold of 10%. Because only the operations across the seam are noisy (one of the 4 per plaquette), even qubits on the seam are only subjected to 1 out of 4 noisy operations. An advantage of this approach is that qubits on the seam only experience one teleported gate out of four total, making them an additional factor less sensitive to teleported gate errors than the phenomenological model would naively indicate.

As shown in FIG. 1, the noisy teleported gates only touch one row of qubits and syndromes in each code patch.

Propagating the errors for the teleported gate onto the qubits proceeds as follows. For Bell pair infidelity p_{B}, an error channel is assumed where the Bell pair is perfectly created with probability 1−p_{B}, and with probability

$$\frac{{p}_{B}}{15}$$

each of the following operators is applied to a perfect Bell pair: IX, IY, IZ, XI, XX, XY, XZ, YI, YX, YY, YZ, ZI, ZX, ZY, ZZ. As the Bell pair is stabilized under the application of XX, ZZ, all 15 of these are equivalent to II will

$$\frac{{p}_{B}}{5}$$

and IX, IY, or IZ with probability

$$\frac{4 {p}_{B}}{15} .$$

In an exemplary phenomenological model, qubits experience an average level of noise based on how often they are hit with errors originating from teleported and local gates.

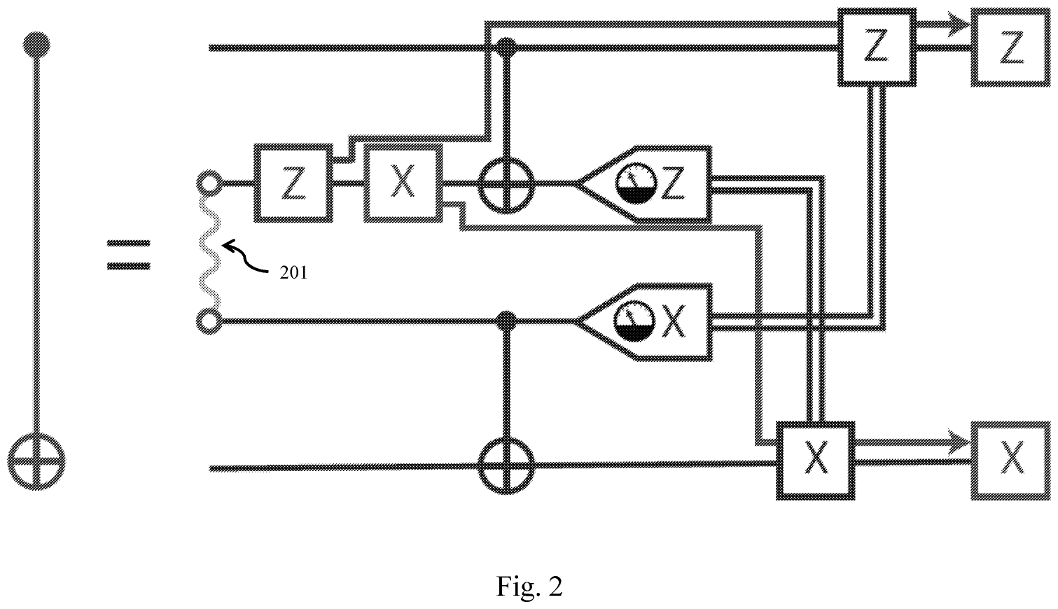

Referring to FIG. 2, an exemplary circuit is provided in which X, Z errors on the Bell pair used in the teleported gate propagate to the two qubits it operates on.

A similar model applies for CNOT gates (p_{CNOT}). Propagating the errors for Bell and local gates from the model shown in FIG. 2 yields:

From Bell pair errors:
X on target with

$$\frac{8 {p}_{Bell}}{15}$$

Z on control with

$$\frac{8 {p}_{Bell}}{15}$$

From internal CNOT errors:
X on control with

$$\frac{8 {p}_{CNOT}}{15}$$

X on target with

$$\frac{8 {p}_{CNOT}}{15} + \frac{8 {p}_{CNOT}}{15}$$

From measure errors:
X on target with p_{M}

Summing up the errors, the teleported gate gives for X errors:

$$control : \frac{8 {p}_{CNOT}}{15}$$

$$target : \frac{8 {p}_{Bell}}{15} + 2 \times \frac{8 {p}_{CNOT}}{15} + {p}_{M}$$

The following analysis looks to a data qubit on smaller scale modules. During each code cycle, a data qubit is a target twice, and a control twice by teleported gates.

$${p}_{small} = 2 \times ( \frac{8 {p}_{Bell}}{15} + 2 \times \frac{8 {p}_{CNOT}}{15} + {p}_{M} ) + 2 \times ( \frac{8 {p}_{CNOT}}{15} ) = 2 \times \frac{8 {p}_{Bell}}{15} + 6 \times \frac{8 {p}_{CNOT}}{15} + 2 {p}_{M} \approx {p}_{Bell} + 3 {p}_{CNOT} + 2 {p}_{M} \qquad Equation 2$$

$${p}_{small} \approx {p}_{Bell} + 3 {p}_{CNOT} + 2 {p}_{M} \qquad Equation 3$$

With regard to a syndrome qubit on a small module, consider a plaquette where the syndrome is the target of a teleported CNOT four times, then gets measured incorrectly with p_{M}.

$${q}_{small} = 4 \times ( \frac{8 {p}_{Bell}}{15} + 2 \times \frac{8 {p}_{CNOT}}{15} + {p}_{M} ) + {p}_{M} = 4 \times \frac{8 {p}_{Bell}}{15} + 2 \times \frac{8 {p}_{CNOT}}{15} + 5 {p}_{M} \approx 2 {p}_{Bell} + 4 {p}_{CNOT} + 5 {p}_{M} \qquad Equation 4$$

$${q}_{small} \approx 2 {p}_{Bell} + 4 {p}_{CNOT} + 5 {p}_{M} \qquad Equation 5$$

This is the probability that the syndrome gets bit flipped erroneously. Similar counting applies for star operators.

The following provides a seam system analysis. Note that so far X errors have only been simulated along the seam in the case where it should be weakest.

In the bulk, the gates are not teleported:

$${q}_{bulk} = 4 \times \frac{8 {p}_{CNOT}}{15} + {p}_{M} \approx 2 {p}_{CNOT} + {p}_{M} \qquad Equation 6$$

$${q}_{bulk} \approx 2 {p}_{CNOT} + {p}_{M} \qquad Equation 7$$

$${p}_{bulk} = 4 \times \frac{8 {p}_{CNOT}}{15} \approx 2 {p}_{CNOT} \qquad Equation 8$$

$${p}_{bulk} \approx 2 {p}_{CNOT} \qquad Equation 9$$

Along the seam, there are three operations on the same side with local CNOTs, and then one teleported gate. It is important to consider whether the seam is operating in the X_{L} or Y_{L} directions. Operating on the X_{L} direction, it is more important to worry about X error correction, same as for Z_{L}.

Considering a plaquette, which is the target of three local CNOTs:

$$3 \times \frac{8 {p}_{CX}}{15} ,$$

which are added to one teleported target error and one final p_{M}:

$${q}_{seam} = 3 \times \frac{8 {p}_{CX}}{15} + ( \frac{8 {p}_{B}}{15} + 2 \times \frac{8 {p}_{CX}}{15} ) + {p}_{M} \approx 0.5 {p}_{B} + 2.5 {p}_{CX} + 2 {p}_{M} \qquad Equation 10$$

$${q}_{seam} \approx 0.5 {p}_{B} + 2.5 {p}_{CX} + 2 {p}_{M} \qquad Equation 11$$

and considering a data qubit

$${p}_{seam} = 3 \times \frac{8 {p}_{CX}}{15} + ( \frac{8 {p}_{B}}{15} + 2 \times \frac{8 {p}_{CX}}{15} + {p}_{M} ) + {p}_{M} \approx 0.5 {p}_{B} + 2.5 {p}_{CX} + {p}_{M} \qquad Equation 12$$

$${p}_{seam} \approx 0.5 {p}_{B} + 2.5 {p}_{CX} + {p}_{M} \qquad Equation 13$$

Bringing these together, code patches of distance size 3-15 with noisy seams are simulated in order to determine the effect of the seam on the code thresholds, where the probability of an error on the seam is given by pₛₑₐₘ and the probability of an error elsewhere is given by p_{bulk}.

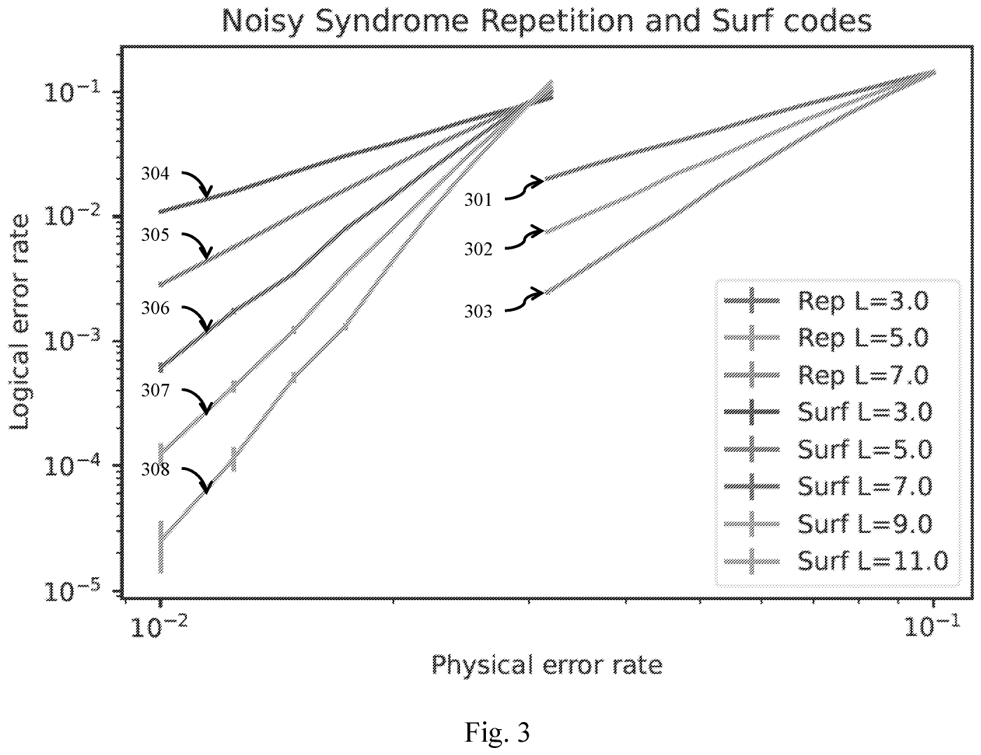

Referring to FIG. 3, the seam and bulk thresholds are compared. A surface code has a threshold of about 10%, while a repetition code has a threshold of about 50%. Repetition codes with L=3.0, 5.0, and 7.0 are shown by lines 301, 302, and 303, respectively. Surface codes with L=3.0, 5.0, 7.0, 9.0, and 11.0 are shown by lines 304, 305, 306, 307, and 308, respectively.

As explained above, fault-tolerant communication between surface code patches requires maintaining a surface code across two modules. This can be accomplished using teleported gates to carry out stabilizer checks across the seam, which in turn requires distributed Bell pairs. FIG. 3 shows that for large surface code patches, the fidelity of the distributed Bell pairs can be very low, without substantially affecting the quality of local operations necessary to reach threshold. Therefore, it is shown that the local gate requirements necessary to run local code patches can be decoupled from the fidelity of Bell pairs required to connect them. This is in marked contrast with alternative distributed architectures, which generally rely on distillation to reach a target fidelity, increasing the requirements on local operations by approximately a factor of 10. Therefore, large modules possess a significant advantage for scaling, tolerating low fidelity connections without any cost imposed on local operations. Until recently, however, the only hardware platforms with natural photonic integration (trapped ion chains, NV centers) were constrained to small module sizes, or local operations rapidly degrading with system size. In contrast, Rydberg arrays can support large numbers of atoms without local gate degradation, and naturally support photonic integration.

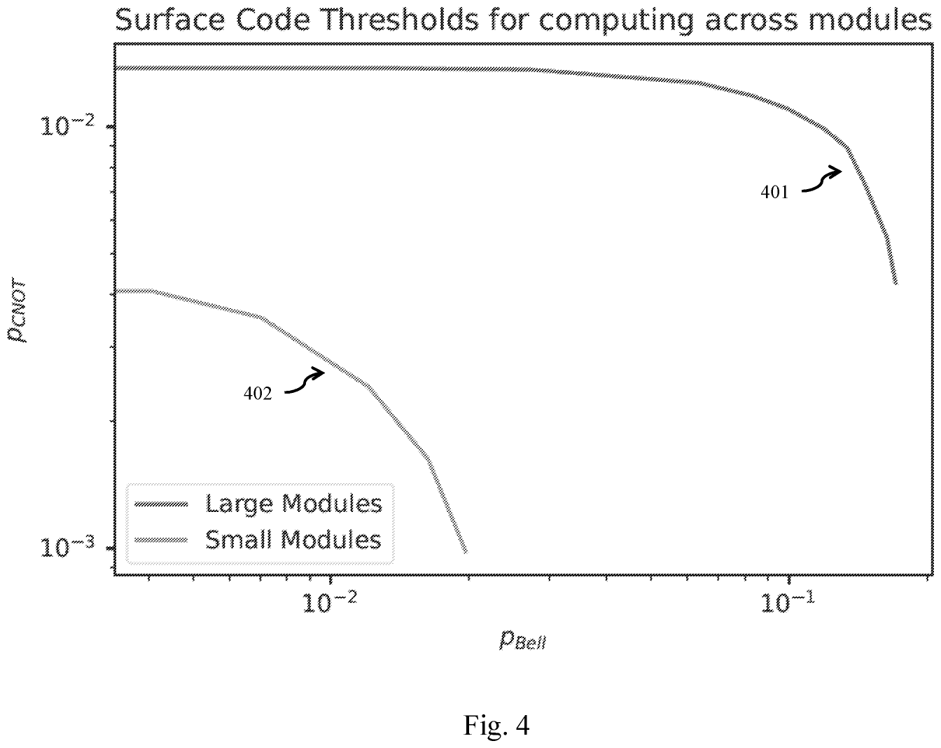

Referring to FIG. 4, thresholds for large modules (those using seam architecture) 401 and small modules (those using one data or syndrome qubit per module) 402 are compared in terms of both local CNOT error (p_{CNOT}) and Bell pair error (p_{Bell}). Even for p_{Bell}=0, small modules require better p_{CNOT} because of the extra local gates necessary for gate teleportation. Additionally, for small modules, once p_{Bell}>0, P_{CNOT} must be rapidly decreased to compensate. In contrast, for large modules, p_{Bell} does not affect the required p_{CNOT} until it is increased to around 10%.

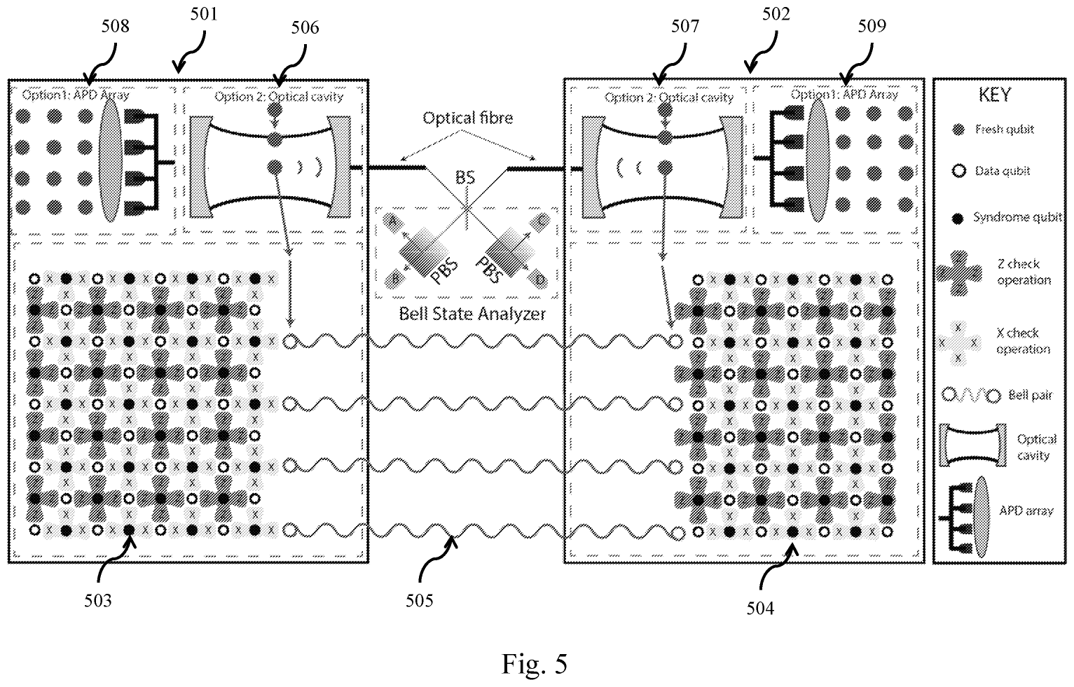

Referring to FIG. 5, a system for quantum computation is illustrated, comprising two modules 501, 502 equipped with sufficient quantum I/O for fault-tolerant communication. Surface code patches 503, 504 in each module are realized using an array of atoms, and connected using teleported gates. The Bell pairs 505 necessary to perform the teleported gates are generated using either an optical cavity (506, 507) or highly multiplexed free-space collection such as an APD array (508, 509). Once a Bell pair 505 is created, it is transported to the seam and used to enact a stabilizer check across the seam. The cavity can also be used to speed up qubit readout, by transporting syndrome qubits back into the cavity when readout is desired.

In view of the above discussion of logical gates between modules without needing to increase the fidelity of local operations, implementation with Rydberg arrays requires generating moderate quality Bell pairs with sufficient rates to perform all of the stabilizer checks across the seam quickly enough. The objective is to do codes cycles fast enough to beat decoherence, so that errors are detected and corrected faster than they are introduced.

To be 10× below the surface code threshold of ˜1%, for example, with demonstrated intrinsic qubit decoherence timescales τ=1 s, would require code cycles every 1 ms or less, so that storage errors only contribute errors of 10⁻³ per qubit within each code cycle. This means that an entire round of stabilizer checks is required, both within the bulk of each surface code patch (around d² checks) and across the seam connecting the patches (about d checks), within 1 ms.

As the local Rydberg gates themselves are exceedingly fast (about ˜0.1 μs), the time bottlenecks for realizing all these stabilizer checks will be distributing all the Bell pairs and reading out all the syndrome qubits.

To show this can all be done sufficiently quickly, a concrete choice of parameters is provided for a fault-tolerant quantum computer of logical gate fidelity capable of executing Shor's algorithm for a N=2000 bit number (2N logical qubits and ˜10⁻¹² logical gate errors). With local Rydberg gates operating 10× below threshold, this can be achieved by a surface code with an edge length of d=20, containing approximately 4×20²=1600 physical qubits (1521 to be exact).

A scheme using a single optical cavity with the following parameters is sufficient:

$${T}_{2} = 200 ppm \qquad Equation 14$$

$${α}_{loss} = {T}_{1} + {L}_{1} + {L}_{2} = 15 ppm \qquad Equation 15$$

$$L = 4 mm \qquad Equation 16$$

$$w = 10 μm \qquad Equation 17$$

$${η}_{collect} = \text{.68} \qquad Equation 18$$

From these parameters, the following quantities can be derived:

$${τ}_{cav} = \frac{2 L}{c} \frac{1}{{T}_{1} + {T}_{2} + {L}_{1} + {L}_{2}} = 0.12 μs \qquad Equation 19$$

$$κ = 1 / {τ}_{cav} = 2 π \times 0.69 MHz \qquad Equation 20$$

$$Γ = 2 π \times 6 MHz \qquad Equation 21$$

$$V = \frac{π {w}^{2} L}{4} \qquad Equation 22$$

$$g = μ \sqrt{\frac{ω}{2 {ℏϵ}_{0} V}} = 2 π \times 8.2 MHz \qquad Equation 23$$

$$C ≡ \frac{{g}^{2}}{κΓ} = 8.5 \qquad Equation 24$$

With these modest optical cavity parameters, the required time per code cycle for generating all the necessary Bell pairs and reading out all the syndrome qubits can be estimated. From this, an exemplary workflow detailing continuous operation of sufficient quality to enable the final fault tolerant logical gates between modules is described below.

### Entanglement Generation

Shared entanglement between modules is the basis for quantum communication. For generating shared Bell pairs, a protocol may be employed in which photons entangled with suitably prepared individual atoms are collected. Because each photon is entangled with its atom, a Bell state measurement of two such photons will project the two atoms into a Bell state. The resulting atom-atom entanglement is probabilistic (collection is imperfect), but heralded (by successful joint detection). Once a shared Bell pair has been produced, local operations within a module plus classical communication between modules can be used to teleport quantum information or enact a teleported gate. Achieving a sufficiently fast Bell pair production rate is crucial for any modular architecture.

In alternative architectures comprising modules with a small number of qubits, the primitive operation at the level of the quantum error correcting code level is a teleported gate, meaning that the Bell pair production rate determines the code cycle time (and consequently must be fast enough to keep idling errors below the code threshold). In the architecture presented herein, modules are large, containing surface code patches running on hundreds or thousands of qubits, and teleported gates are required to realize fault-tolerant operations between modules.

The resulting requirements on Bell pair production rates are even more stringent. For example, a transversal CNOT operation between two distance d logical qubits in separate modules involves 4d² teleported CNOTs. Furthermore, no error correction can be performed mid-CNOT, as performing a subset of the CNOTs takes the system out of the code space. Conveniently, other methods of fault-tolerant logical operations are available. It turns out that the minimum communication required to perform fault-tolerant operations between modules is the amount of communication which would be required to simply maintain a code patch straddling two modules.

To maintain a code patch straddling two modules, 2d star and plaquette stabilizer checks must be performed across the seam using teleported gates, requiring 2d Bell pairs. At this point, various methods of logical operations including braiding or lattice surgery can be performed with modest (˜2×) overheads in qubit number. For this architecture to work, therefore, Bell pair production rates must be sufficiently fast to generate 2d Bell pairs in less than 1/1000th of the coherence time (τ_{C}=1 s).

### Cavity Enhanced Entanglement Rates

A cavity in each module enables fast photon extraction, used to entangle atoms in each of the two cavities. An atom in each cavity emits photons, which are collected and routed with optical fibers to a common location and measured with photodetectors, entangling the atoms. To estimate the rate of entanglement generation achievable with the cavity parameters provided above, the photon collection efficiencies, the corresponding entanglement success probabilities, and the repetition rate are estimated below.

Single photon emission success probability for emission is given in Equation 25.

$${P}_{S} = \frac{4 C}{1 + 4 C} \frac{{T}_{2}}{{α}_{loss}} = 0.9 \qquad Equation 25$$

Bell pair success probability is given in Equation 26

$${P}_{Bell} = \frac{1}{2} {( {η}_{collect} {P}_{S} )}^{2} = 0.19 \qquad Equation 26$$

Waiting for 4 ringdown times to avoid crosstalk gives a repetition time of 4τ_{cav}=0.48 μs. This gives an average time until success of 0.48/0.19=2.5 μs per Bell pair. A minimum of 2d=40 Bell pairs per code cycle are required, so for each code cycle, the time spent entangling atom pairs is then 40×2.5 μs=100μs.

Similar results would be observed with an implementation having seams around all 4 edges of a patch.

### Free-Space Entanglement Rates

An alternative to using a cavity is free-space collection, such as with an APD array described above. Free-space entanglement generation is implemented with a connecting unit consisting of a lens collecting light which is scattered from a suitably prepared atom into free space, where the light from each atom is focused and coupled into an individual fiber in an array of fibers and independently detected. A Bell-state measurement of photons emitted from two separate atoms results in probabilistic but heralded entanglement between the two atoms via entanglement swapping. Local operations can then be used to enact a teleported gate.

To estimate the rate of entanglement generation achievable with free-space methods, the photon collection efficiency is estimated first, then the corresponding entanglement success probabilities, and the repetition rate for one atom, and then multiplied by the number of atoms which one is trying to entangle in parallel.

Single photon collection efficiency is taken to be:

$${η}_{collect} = 0.18 \qquad Equation 27$$

Bell pair success probability is given as:

$${P}_{Bell} = \frac{1}{2} {( {η}_{collect} {P}_{detect} )}^{2} = 0.0079 \qquad Equation 28$$

The repetition time is 7 μs, limited by repumping time, with another overall factor of 50% in duty cycle assumed for periodic recooling.

The average time until success of 14/0.0079=1.8 ms. If one attempts to entangle 500 atoms at a time, the average time to produce a single Bell pair will be 3.6 μs. One needs 2d=40 Bell pairs per code cycle, so for each code cycle, the time required to generate the necessary entangled pairs is 40×3.6 μs=144 μs, much faster than the target of 1 ms.

If repumping and cooling times are performed elsewhere, with fresh atoms being continually placed into position, the repetition time can be expected to decrease. Assuming such highly parallelized preparation and motion is possible, a repetition time faster than 1 μs may be achieved, requiring significantly less parallelization.

### Readout Rates

In addition to creating the Bell pairs, reading out 2d Bell pair qubits and 2d² syndrome qubits is required every code cycle.

The cavity 506, 507 can be used to very quickly read out the Bell pairs used for teleportation and also to read out the syndrome qubits required for a code cycle quite quickly, much faster than the 2d Bell pairs can be created. In some embodiments, a separate cavity is provided for this readout.

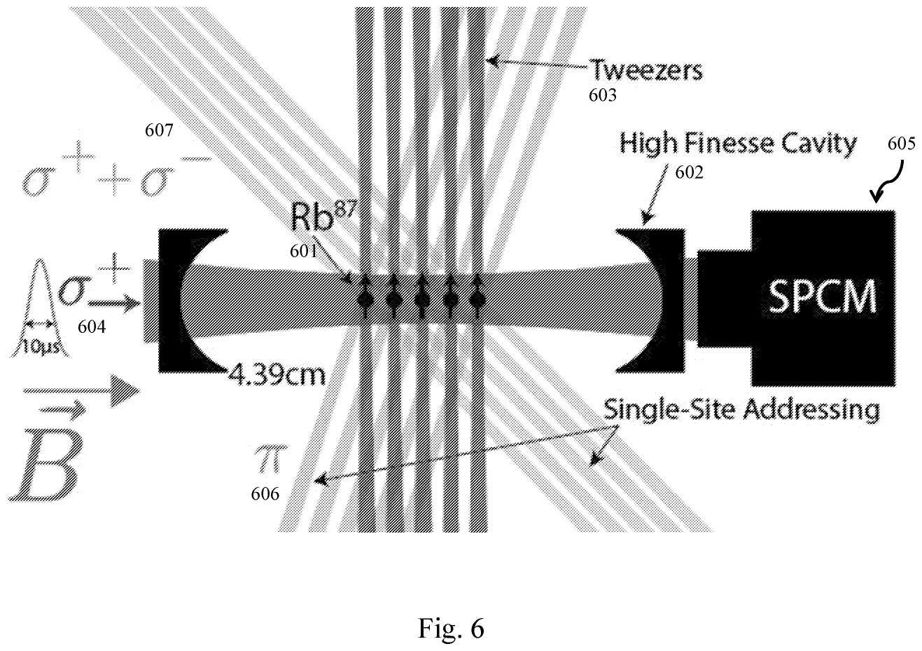

A schematic view of an exemplary cavity configuration is provided in FIG. 6. An array of Rb atoms 601 is disposed in cavity 602, and retained by optical tweezers 603. The optical cavity 602 is driven by a weak laser beam 604, and the presence/absence of transmission through the cavity signals presence/absence of an atom coupled to the cavity, and hence can reveal the state of the atom. With the parameters presented previously, collecting about 10 photons by driving the cavity to transmit/reflect a laser beam of strength 10× below the atomic saturation point is sufficient to achieve an error of 0.001, and this can be done in 0.2 μs of continuous driving. The photons are collected by single photon counting modules (SPCM) 605. Budgeting around a total of t_{read}=1.0 μs per readout event allows time for cavity ringup and ringdown (recall τ_{cav}=0.12 μs).

For each code cycle, two kinds of qubit measurements need to be done. First, each of the 2d teleported gates shown in FIG. 2 requires its associated Bell pair qubit to be measured for feedback. These qubits will be unbiased, with 50% chance to be found in their |0 [symbol] or |1 [symbol] states, and so must be read out individually using the cavity. This means serially reading out 2d=40 Bell pair qubits every code cycle would then take 40×1.0 μs=40 μs.

Second, for each code cycle, the 2d² syndromes in the bulk of the code patch must also be read out. These syndrome qubits, however, are only flipped from |0 [symbol] to |1 [symbol] when an error occurs, which is relatively infrequent. This means that these qubits are highly biased when measured, which allows optimization of reading. Many syndrome qubits can be placed in the cavity simultaneously, and if one or more of them are in |1 [symbol] , the transmission through the cavity will be blocked. Coupling all of the 2d² syndrome qubits simultaneously to the cavity, each qubit actually in the state |1 [symbol] can be found with a logarithmic search of about log₂(2d²) steps by coupling selected subsets of the syndrome qubits to the cavity. With p the chance of each qubit in the error state |1 [symbol] , the mean number of readouts required is (1+p(2d²)log₂(2d²)) per code cycle. For local gates of 0.001 error, and each qubit getting hit with 4 such local gates per code cycle, p=0.004, requiring ˜(1+0.004×800 log₂ 800)=32 readout events, taking about 32 μs for tread=1.0 μs.

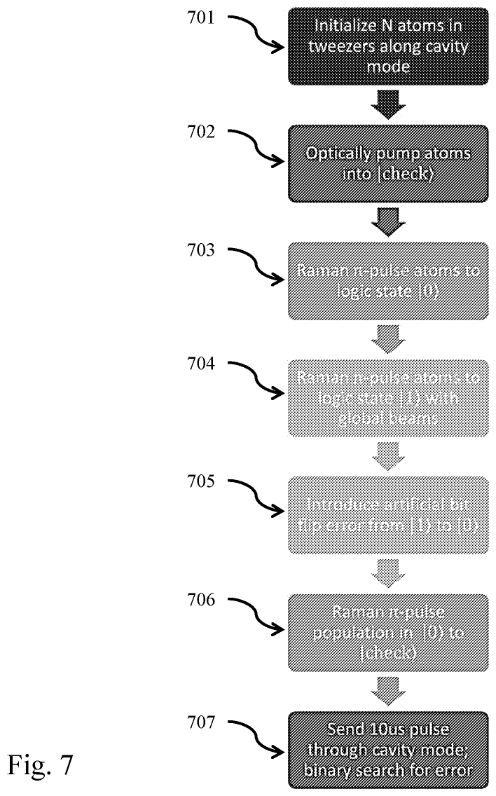

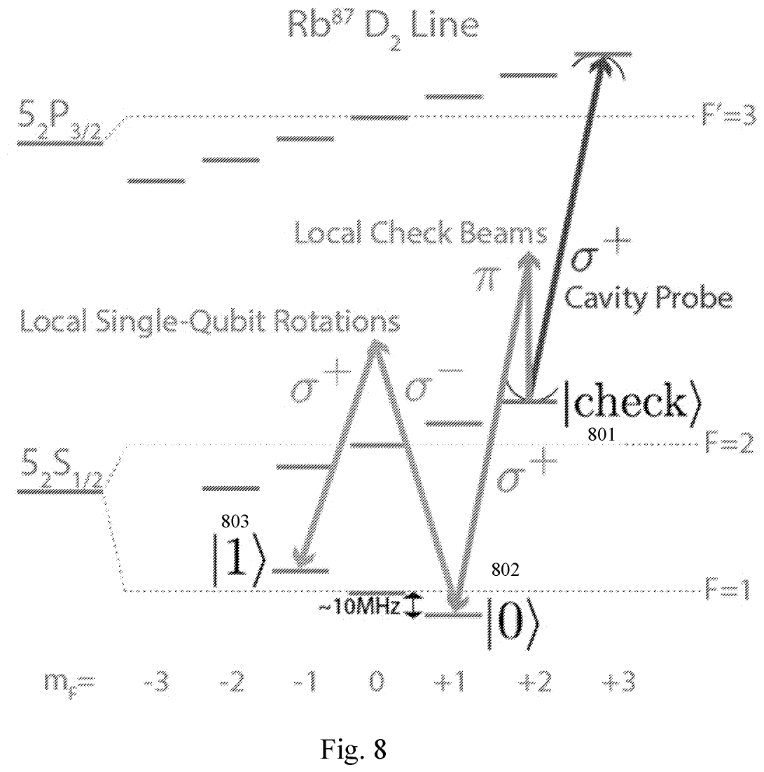

Referring to FIG. 7, a method of collective measurement according to embodiments of the present disclosure is illustrated. In FIG. 8, a corresponding energy level diagram is provided.

At 701, N atoms 601 are initialized in optical tweezers 603. At 702, laser 604 pumps atoms 601 into check state 801. At 703, a Raman π pulse is applied by laser beams 606 to place atoms 601 into the |0 [symbol] state 802. At 704, a Raman π pulse is applied by laser beams 607 to place atoms 601 into the |1 [symbol] state 803. At 705, an artificial bit flip error from |1 [symbol] to |0 [symbol] is introduced. This step is for the purpose of testing, and is omitted when detecting natural errors arising in operation. At 706, a Raman π pulse is applied by laser beams 606 to place atoms 601 having the |0 [symbol] state 802 back to the check state 801. At 707, a 10 μs pulse is applied by laser 604 to detect any atoms in the check state 801. A binary search is performed to identify any atoms in the check state 801 (and thus identify any qubits exhibiting an error).

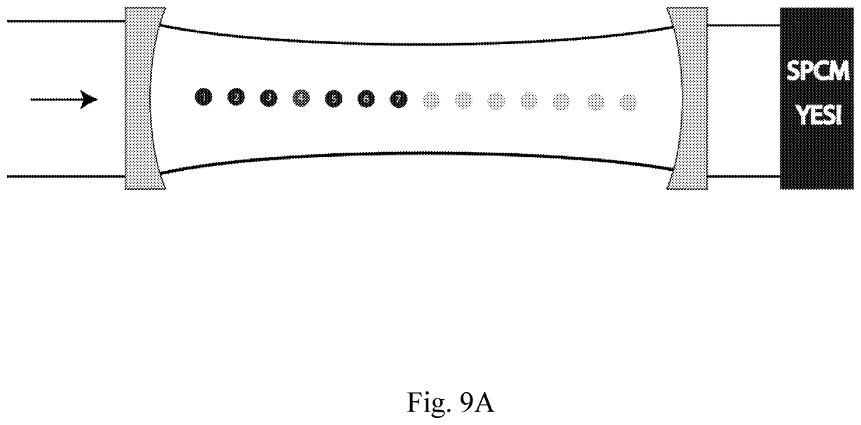

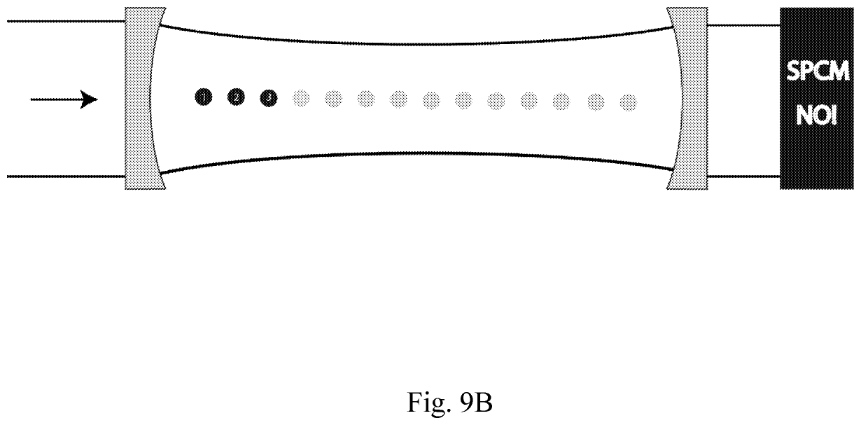

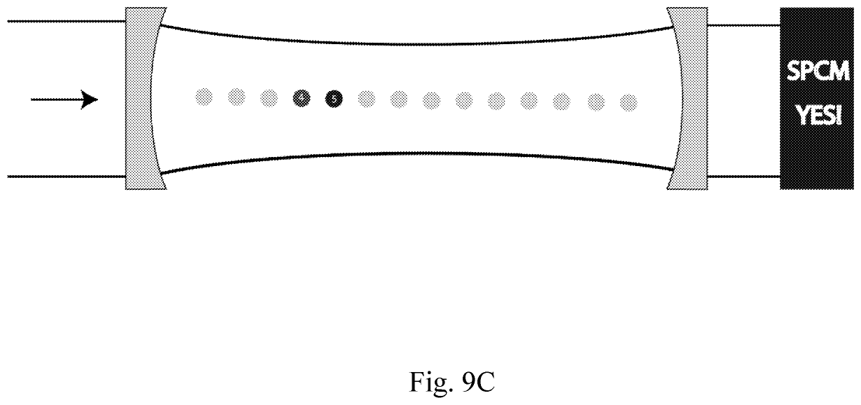

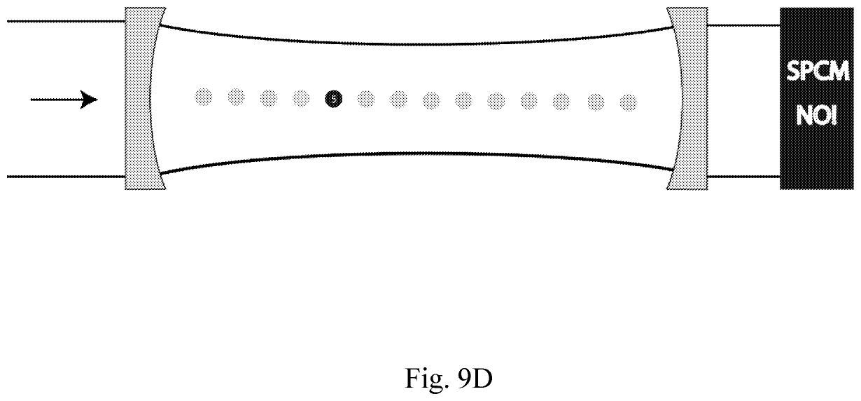

Referring to FIGS. 9A-D, a binary search is illustrated. In this example, seven qubits are searched in four steps. In FIG. 9A, qubits one through seven are placed in the cavity (indicated by the dark color) while qubits eight through fourteen are not placed in the cavity (indicated by the light color). A measurement is performed as set forth above, and the presence of an error in this group of seven qubits is detected, indicated by “SPCM YES!” In FIG. 9B, qubits four through seven (half of the qubits) are removed from the cavity, leaving qubits one through three. A measurement is performed, indicating that there is no error in qubits one through three, indicated by “SPCM NO!” Accordingly, the error must be in qubits four through seven. In FIG. 9C, qubits one through three are removed from the cavity and half of the qubits (four through five) are reintroduced. A measurement is performed, indicating that there is an error in qubits four through five. In FIG. 9D, half of the qubits are removed from the cavity, leaving only qubit five. A measurement is performed, indicating that there is no error in qubit five. Accordingly, the error must be in qubit four.

### Workflow

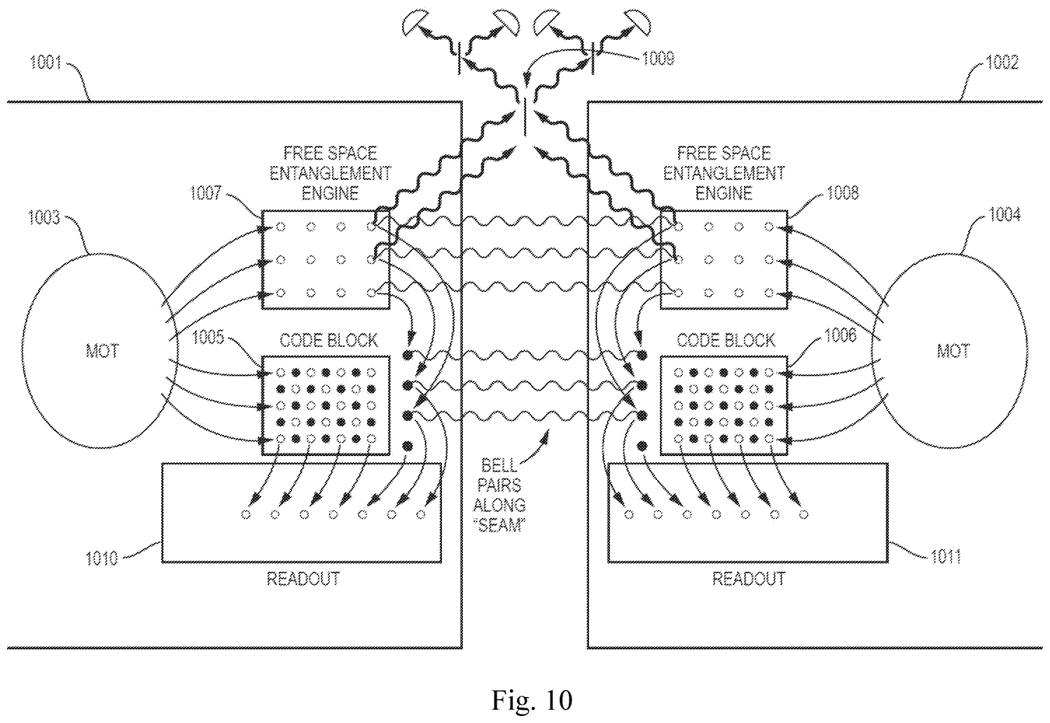

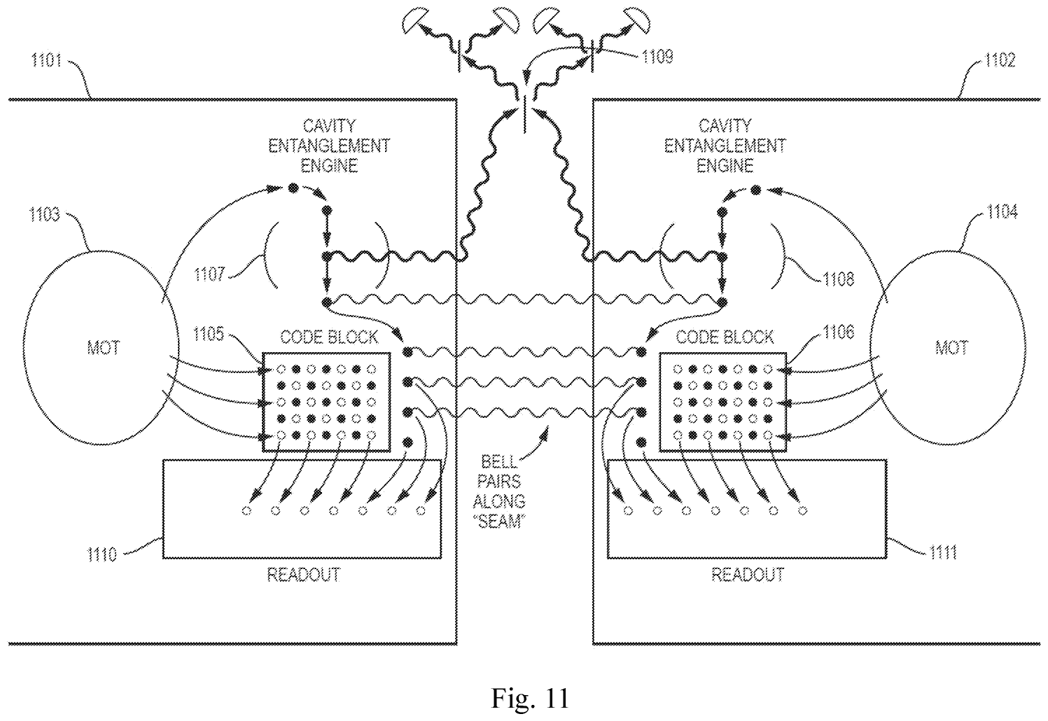

As discussed above, FIG. 5 depicts two unit modules 501, 502, each consisting of an atom array 503, 504 and an optical cavity 506, 507. The workflow is further illustrated with reference to FIGS. 10-11, which provide a schematic view of free space entanglement and cavity entanglement embodiments, in which arrows indicate transport of atoms. Modules 1001, 1002, 1101, 1102 include a magneto-optical trap (MOT) 1003, 1004, 1103, 1104 which serves as a source of atoms. Atoms are moved to a code block (Rydberg array) 1005, 1006, 1105, 1106 and to either a free space entanglement apparatus 1007, 1008 such as an APD array or to a cavity entanglement apparatus 1107, 1108. Atoms are initialized in tweezers and loaded into locations suitable for entangling operations via the cavity or Rydberg gates. For each code cycle to run the error correcting code, 2d Bell pairs for communication between the two modules are generated using photons 1009, 1109 extracted with the optical cavities or free space entanglement, which takes a total time of ˜100 μs.

After entanglement is heralded by detecting the extracted photons, Bell pairs are transported, taking around ˜100 μs, to the required locations at the edge of the array 1005, 1006, 1105, 1106 where they will be used to enact teleported gates for syndrome checks across the seam, effectively merging the two atom arrays into a single logical code patch. Once the entangled pairs are positioned, local Rydberg gates between data and syndrome qubits realize the parity check syndrome operations of FIG. 5, which takes only a few microseconds.

Once all of the local Rydberg gates are done, Bell pair qubits and syndrome qubits can be transported back to a cavity 1010, 1011, 1110, 1111 for fast non-destructive readout, requiring as previously estimated, around 40 μs and 30 μs, respectively.

In total, even if each of the different steps described above is done serially, the time for a single error correcting code cycle is still a few hundred μs, which is less than the 1 ms desired target, assuming the demonstrated 1 s coherence times.

These code cycles are then continuously repeated, and every d code cycles are sufficient to realize a fault-tolerant logical gate between the two code patches in the two modules.

With a large number of such modules, and with optical fiber links connecting them all, arbitrary logical gates are fault tolerantly implemented between any of the logical qubits in any of a plurality of modules on the 1-10 ms timescale.

In FIG. 4, the threshold requirements for large module architectures as described herein (FIG. 5) and those of a small module architecture are compared. The local gate threshold is plotted as a function of the Bell pair infidelity, showing that the present approach enables the implementation of a surface code with higher error rates than previously considered possible.

Referring back to FIG. 1, two independent surface code patches can each sustain, protect, and error correct a logically encoded qubit by repeatedly interacting with nearby physical qubits (black filled and open circles). These interactions between nearby physical qubits in the same code patch are two-qubit gates such as Rydberg gates, and, as they occur between physical qubits in the same code patch, they may be referred to as local operations. The error correction within each code patch can successfully function so long as these local operations are done with sufficiently low error rates (for the surface code this is an error rate of about 1%). To then get the two logical qubits in the two code patches to interact, interactions between qubits in separate code patches are required, shown by two-qubit CNOT gates 104 in FIG. 1, which may be referred to as nonlocal operations. These nonlocal operations are more difficult to achieve with high fidelity than local operations, as they occur between physically distant code patches. In the systems provided herein, they are realized through the use of Bell pairs distributed between the two code patches which enable long-distance teleported CNOT gates.

Conventional analysis would assume that nearly perfect local operations («1%) are necessary to make up for nonlocal operations having higher operation error (e.g., ˜10%).

In contrast, the analysis provided herein shows that two code patches can be made to successfully interact with higher error nonlocal operations without having to substantially lower the local operation errors. The present disclosure thus surprisingly enables interacting code patches with nonlocal operation errors of 10% while still using local operations with around 1% errors.

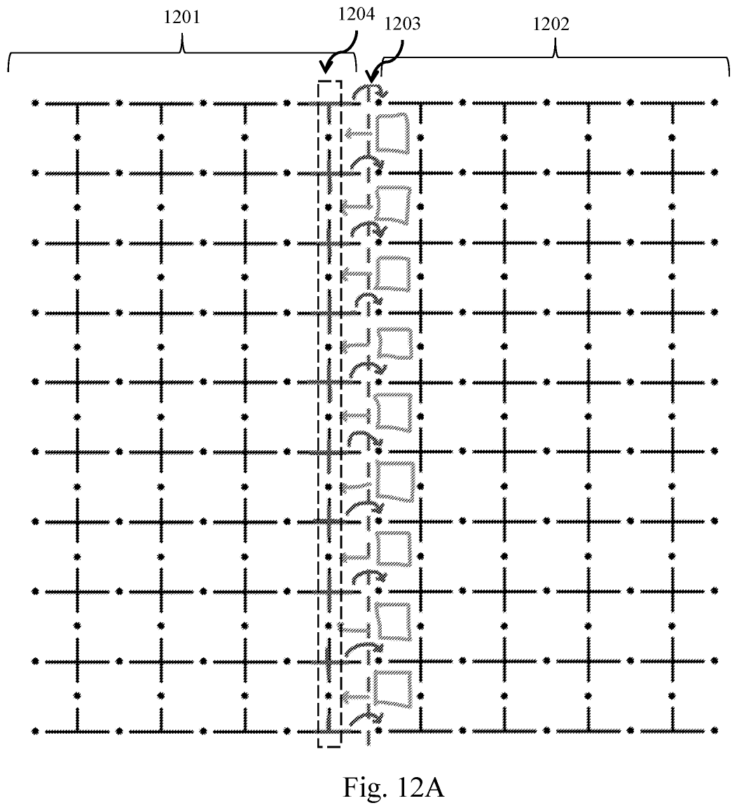

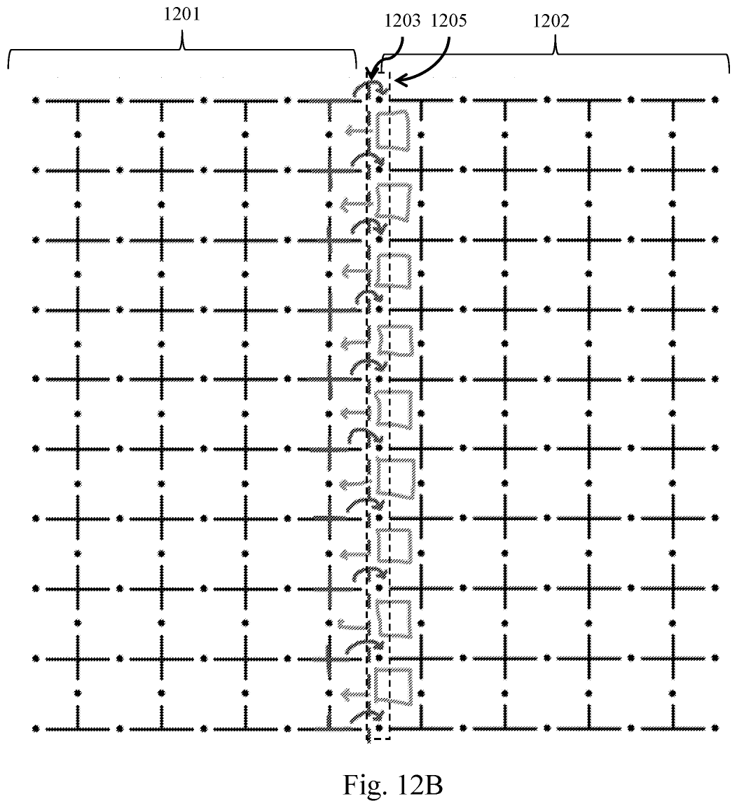

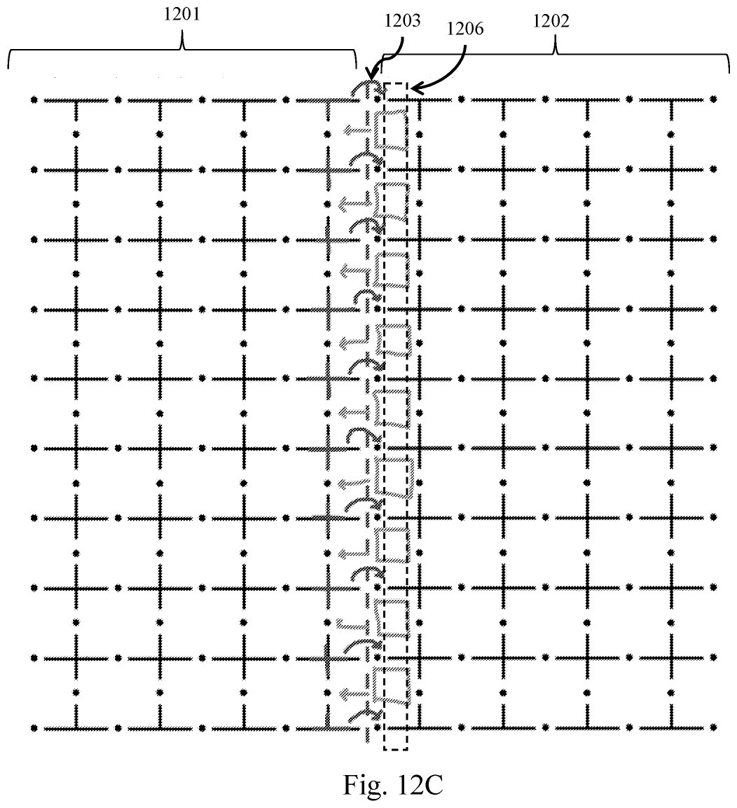

Referring to FIGS. 12A-C, the error arising from a seam is illustrated. Modules 1201, 1202 each implement a surface code and are connected by seam 1203. FIG. 12A shows that only one row 1204 of star operators experiences a higher rate of bit flip and phase flip errors near seam 1203. No matter how many of these operators experience a phase-flip error, it is always detectable and does not cause a logical error. FIG. 12B shows that only one row 1205 of data qubits experience a higher rate of bit-flip errors. If a majority of these data qubits experience a bit-flip error, a logical error occurs. FIG. 12C shows that only one row 1206 of plaquette operators experience a higher rate of bit-flip errors.

The seam thus forms a quasi-1D system with 2 rows of qubits that experience errors at a higher rate, but with only one row corresponding to a logical bit-flip, and a row of plaquette operators and a row of star operators that also experience errors at a higher rate. Accordingly, imperfect syndrome extraction is integrated into threshold simulations.

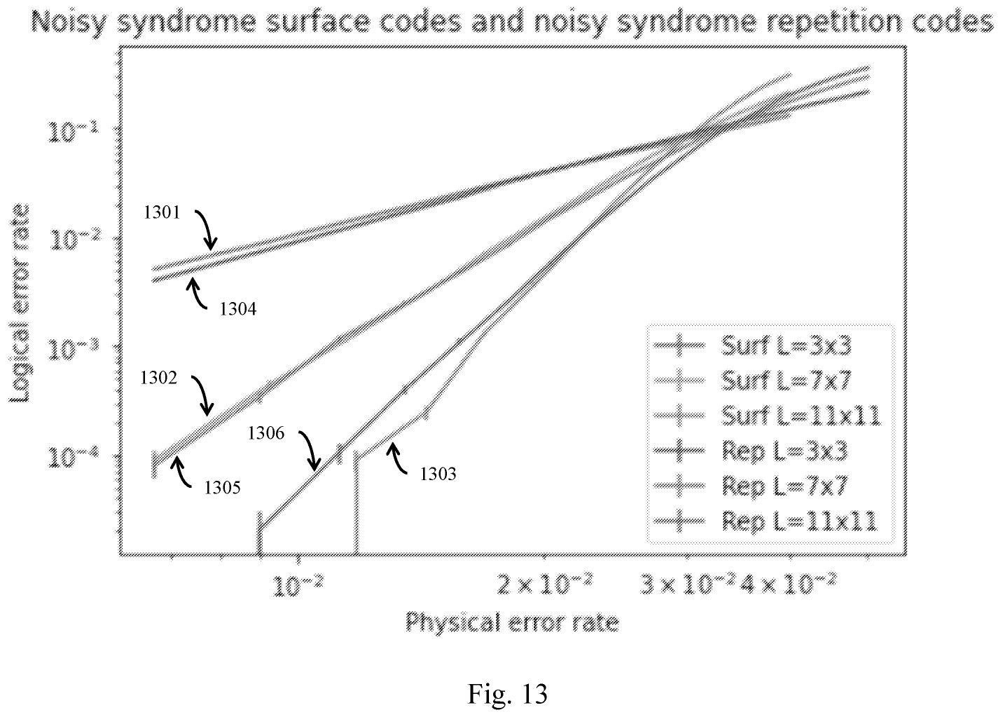

Referring to FIG. 13, the results of numerical simulations with noisy syndromes are illustrated. A surface code with noisy syndromes has a threshold of about 3%. A repetition code with noisy syndromes has a threshold of 10%. Both are plotted here, assuming the error rate for the repetition code is 3× larger than for the surface code. Surface codes with L=3×3, 7×7, and 11×11 are shown by lines 1301, 1302, and 1303, respectively. Repetition codes with L=3×3, 7×7, and 11×11 are shown by lines 1304, 1305, and 1306, respectively.

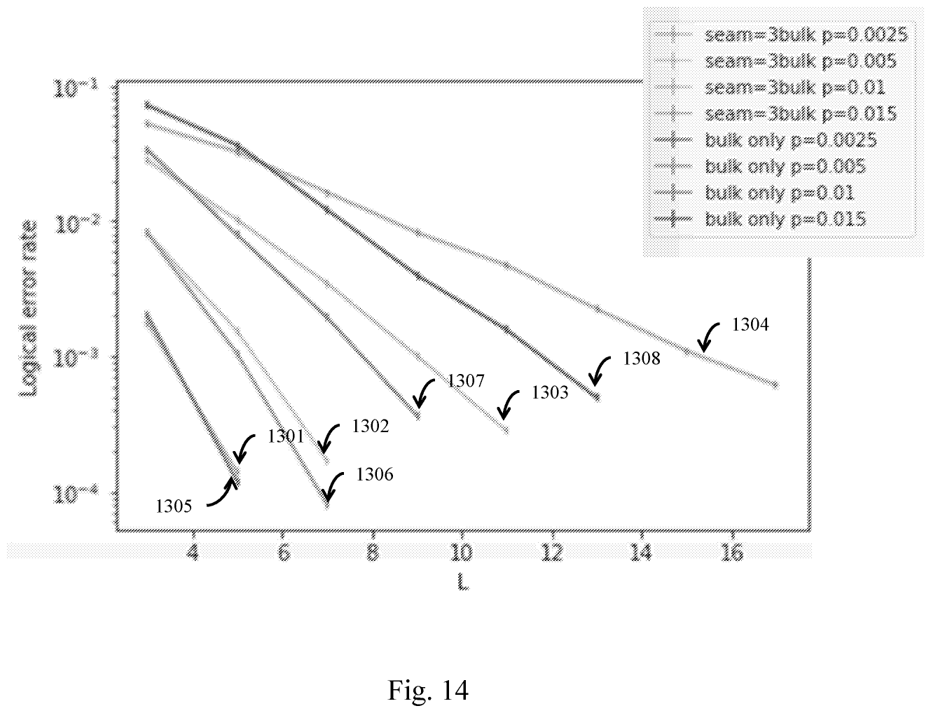

Referring to FIG. 14, a comparison between an L x L code with and without a seam is illustrated. These charts include noisy syndrome extraction and assume seam errors are 3× worse than seam errors. The prefactor is removed to more easily compare the slope. Codes with a seam and p=0.0025, 0.005, 0.01, and 0.015 are shown by lines 1301, 1302, 1303, and 1304, respectively. Codes without a seam and p=0.0025, 0.005, 0.01, and 0.015 are shown by lines 1305, 1306, 1307, and 1308, respectively.

### Network Noise Propagation for Teleported Gates

When the interface is realized via distributed entanglement, that entanglement serves as a resource for enacting non-local, teleported gates between qubits in distinct modules. FIG. 2 shows how bit and phase flip noise on the distributed Bell pair propagates to the control and target qubits in the distinct modules that the teleported gate acts on. The propagation is identical for errors occurring on either of the Bell pair qubits, as must be the case since the Bell pair is invariant under application of XX and ZZ. The X and Z noise on a Bell pair (shown by squiggle 201) used in a teleported gate propagates to the two qubits it operates on. Phase flips only propagate to the control, and bit flips only propagate to the target.

### Bounds

One can lower bound the phenomenological thresholds for surface codes by counting walks corresponding to homologically nontrivial error chains. A surface code with noiseless syndromes can be decoded by pairing up defects on a lattice in 2D, and, to include noisy syndromes, this is extended to the problem of pairing up defects which additionally propagate in time as a 3D matching problem. Previous bounds in 2D and 3D, while not tight, were within about a factor of 3 of the true thresholds.

To illustrate the error chains in a “bulk” matching graph lattice (dimension D_{b}) containing a “seam” subspace lattice (dimension Dₛ<D_{b}), the number of walks and their probabilities are counted, including those which span across both the bulk and the seam. For the cases of interest (D_{b}=2, Dₛ=1 for noiseless syndromes and D_{b}=2+1, Dₛ=1+1 for noisy syndromes), pairing defects on the matching graph allows decoding of the surface code of corresponding dimension. When the bulk is operating slightly below its own threshold, one can quantify how the probability of long “excursions” away from the seam is strongly suppressed. The results are evaluated for the case of greatest interest (D_{b}=3, Dₛ=2), showing it is possible to increase noise on the seam in exchange for a modest decrease of noise in the bulk.

While these bounds are not tight, and the combinatorics tracking the hopping between seam and bulk over-counts the walks to give less impressive results than revealed by the exact numerical simulations, the derivation illustrates many core concepts important to understand the results and also provides insight into more complex situations, such as how the code performance is affected by having multiple different seams operating within the same bulk.

### The Matching Graph and the MWPM Decoder

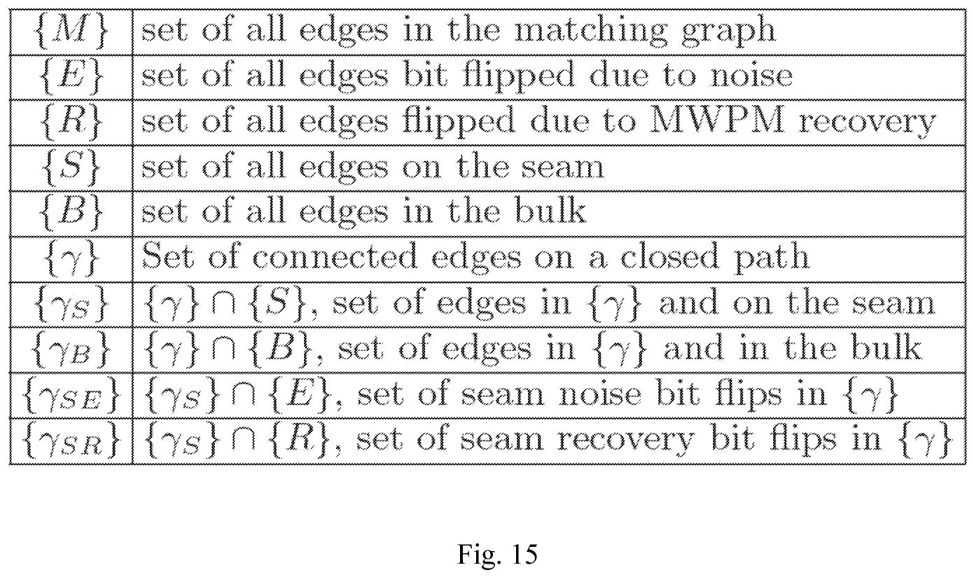

FIG. 15 provides a glossary of terms for the following discussion.

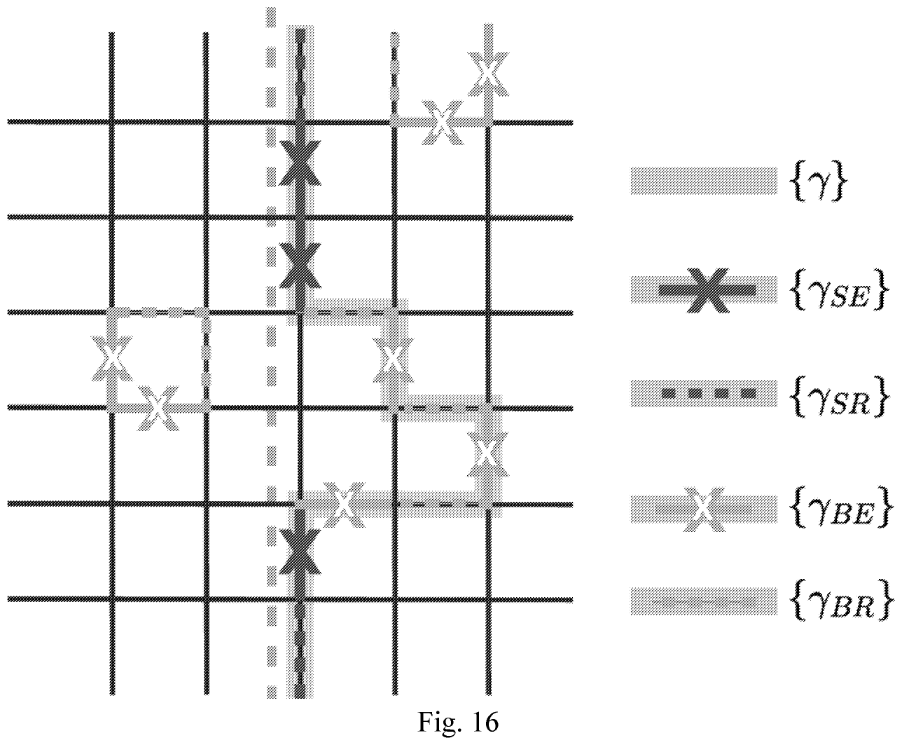

FIG. 16 illustrates an exemplary matching lattice.

The set {M} of edges in the matching lattice corresponds to data qubits, and its vertices correspond to syndromes, such that the vertices forming the boundary ∂ of a set of errors on {M} correspond exactly to the violated checks.

Logical failure occurs if during a round of error correction, enough bits are flipped by environmental noise combined with the attempted correction to form some nontrivial chain {γ} spanning the code. Each round, errors introduce a random set {E} of bit flips, which occur both on seam edges and on bulk edges as solid and hollow X's, respectively. Minimum weight perfect matching (MWPM) recovery further bit flips the dashed edges {R} on the seam and the bulk to return the state to the codespace. Then, the remaining X's and dashes together for the set {E+R}. In this example, {E+R} contains the nontrivial chain {γ}.

“Edges” refers to locations of qubits in the matching graph. Quantities in brackets { } refer to matching graph subsets, and quantities without brackets refer to the sizes of such subsets. {E} is a (possibly disconnected) set of edges where bit flip errors occurred on a given round of error correction, and {R} is a set of edges chosen via MWPM that are bit flipped to attempt correction of {E}. The sum of the error and recovery steps {E+R}≡({E}\{R})∪({R}\{E}) (symmetric difference) is the resulting set of edges with bit flips left over after a round of noise followed by corrections. The symmetric difference is used since edges that are flipped by errors and also flipped back by the correction are not in a flipped state following the error correction round. {γ} is some path connecting the opposite edges of the surface code with no additional loops or disconnected components. The edges {M} are categorized into two subsets: {S} and {B} for edges in the seam and bulk where errors occur with probabilities pₛ and p_{b}. γ_{S}, γ_{B} refer to the number of edges from these edge categories that intersect with the support of a given γ: γ_{S}≡|{γ_{S}}∩{S}|. The number of seam edges contained in {γ} and {E} is referred to as γ_{SE}≡|{γ_{S}}∩{E}|, and the number of seam edges contained in {γ} and {R} is referred to as γ_{SR}≡|{γ_{S}}∩{R}|.

The syndrome measured given the set of errors {E} is a {E}, which is the set of vertices adjacent to {E}. A given {E} occurs with a probability

$$Prob ( \{ E \} ) = {\prod }_{i ∈ \{ E \}} {p}_{i} {\prod }_{∈ \{ M \} \backslash \{ E \}} ( 1 - {p}_{i} ) ∝ {\prod }_{i ∈ \{ E \}} \frac{{p}_{i}}{1 - {p}_{i}} \qquad Equation 29$$

MWPM then decodes ∂{E} and returns {R}, the set of edges most likely to have resulted in the measured ∂{E}, by maximizing Equation 29, subject to the constraint ∂{R}=∂{E}. MWPM is an efficient classical algorithm known to perform nearly optimally at the task of making {E+R} homologically trivial. This is done by assigning weights

$$log ( \frac{1 - {p}_{i}}{{p}_{i}} )$$

to each edge in {M} and then finding the {R} with the minimum weight such that a ∂{R}=∂{E}:

$$wt ( \{ R \} ) ≡ {\sum }_{∈ \{ R \}} log ( \frac{1 - {p}_{i}}{{p}_{i}} ) \qquad Equation 30$$

### Probability to Fail Via a Particular {γ}

The first goal is to upper bound the probability that a round of errors followed by corrective flips from MWPM will create a set of bit flips containing a particular {γ} with γ_{S} seam and γ_{B} bulk edges and thus result in logical failure. This amounts to bounding the probability that physical errors arise during a round of error correction such that {E+R}⊇{γ} (i.e., that the error chain {γ} is contained within the resulting set of bit flips {E+R}).

By definition, MWPM ensures wt({R})≤wt({E}). For {E+R}⊇{γ}, since {γ} is closed (∂{γ}=∅), it is then the case that {γ}∩{R} and {γ}∩{E} must share a boundary within {γ}. Then wt ({γ}∩{R})≤wt({γ}∩{E}), since if this were not the case, replacing the edges {γ}∩{R} by the edges of {γ}∩{E} would further minimize the weight of {R}, which is impossible by definition because MWPM already minimizes wt ({R}).

It is then the case that {E+R}⊇{γ} implies the two conditions:

$$wt ( \{ γ \} ) = wt ( \{ E \} ⋂ \{ γ \} ) + wt ( \{ R \} ⋂ \{ γ \} ) \qquad Equation 31$$

$$wt ( \{ R \} ⋂ \{ γ \} ) \leq wt ( \{ E \} ⋂ \{ γ \} ) \qquad Equation 32$$

and combining these gives that wt({E}∩{γ})≥wt({r})/2.

Applying the definition of the weight Equation 30, yields the overall implication:

$$\{ E + R \} ⊇ \{ γ \} ⇒ {( \frac{{p}_{s}}{1 - {p}_{s}} )}^{γ S E} {( \frac{{p}_{b}}{1 - {p}_{b}} )}^{γ B E} \leq {( \frac{{p}_{s}}{1 - {p}_{s}} )}^{{γ}_{S} / 2} {( \frac{{p}_{b}}{1 - {p}_{b}} )}^{{γ}_{B} / 2} \qquad Equation 33$$

The following bounds Prob(γ_{SE}, γ_{BE}), the probability of generating an {E} with exactly γ_{SE}, γ_{BE} bit flips overlapping with {γ}. This Prob (γ_{SE}, γ_{BE}) is the number of ways to choose γ_{SE} from γ_{S} and γ_{BE} from γ_{B}, which can be bound since

$$( \begin{matrix}{γ}_{S} \\ {γ}_{SE}\end{matrix} ) \times ( \begin{matrix}{γ}_{B} \\ {γ}_{BE}\end{matrix} ) \leq {2}^{{γ}_{S}} \times {2}^{{γ}_{B}} ,$$

times the probability

$${{p}_{s}^{{γ}_{SE}} ( 1 - {p}_{s} )}^{{γ}_{S} - {γ}_{SE}} {{p}_{b}^{{γ}_{BE}} ( 1 - {p}_{b} )}^{{γ}_{B}} - {γ}_{BE}$$

to actually flip bits at each of those particular choices:

$$Equation 34$$

$$Prob ( {γ}_{SE} , {γ}_{BE} ) \leq {2}^{{γ}_{S} + {γ}_{B}} {{p}_{s}^{{γ}_{SE}} ( 1 - {p}_{s} )}^{{γ}_{S} - {γ}_{SE}} {p}_{b}^{{γ}_{BE}} {( 1 - {p}_{b} )}^{{γ}_{B} - {γ}_{BE}} = {2}^{{γ}_{S} + {γ}_{B}} {( \frac{{p}_{s}}{1 - {p}_{s}} )}^{{γ}_{SE}} {( 1 - {p}_{s} )}^{{γ}_{S}} {( \frac{{p}_{b}}{1 - {p}_{b}} )}^{{γ}_{BE}} {( 1 - {p}_{b} )}^{{γ}_{B}}$$

Now one can bound Prob({E+R}⊇{γ}), the probability of an {E} occurring such that {E+R}⊇{γ}, allowing one to additionally impose the condition from Equation 33, which is substituted into Equation 34 to obtain:

$$Equation 35$$

$$Prob ( \{ E + R \} ⊇ \{ γ \} ) \leq {2}^{{γ}_{S} + {γ}_{B}} {( \frac{{p}_{s}}{1 - {p}_{s}} )}^{{γ}_{S} / 2} {( 1 - {p}_{s} )}^{{γ}_{S}} {( \frac{{p}_{b}}{1 - {p}_{b}} )}^{{γ}_{B} / 2} {( 1 - {p}_{b} )}^{{γ}_{B}} \leq {2}^{{γ}_{S} + {γ}_{B}} {p}_{s}^{{γ}_{S} / 2} {p}_{b}^{{γ}_{B} / 2} \qquad ( 7 )$$

where any explicit reference to the error set {E} has been removed and the failure probability has been bounded only in terms of quantities γ_{S}, γ_{B} dependent on the chosen {γ}.

Since there can only be a logical failure if the round of noise followed by MWPM correction generates a set of bit flips containing some {γ} connecting opposite sides of the surface code, one can next bound the total logical failure probability P_{fail} by summing the failure probability Equation 35 over all such {γ} connecting the two sides of the surface code:

$$Equation 36$$

$${P}_{fail} \leq {\sum }_{\{ γ \}} Prob ( \{ E + R \} ⊇ \{ γ \} \} ) \leq {\sum }_{\{ γ \}} {2}^{{γ}_{S} + {γ}_{B}} {p}_{s}^{{γ}_{S} / 2} {p}_{b}^{{γ}_{B} / 2}$$

### Counting Nontrivial Error Chains

The upper bound on P_{fail} given in Equation 36 still depends on all possible {γ}. In order to obtain an expression that one can evaluate more easily, the following instead sums over the larger set of self-avoiding walks (SAWs) of length [symbol] ≥L. As all {γ} are such SAWs, one can then obtain a still weaker upper bound on P_{fail}. To assign the correct probabilities, the following first discusses a parametrization of the SAWs that accounts for the number of bulk and seam edges contained in them.

Generally, the number of SAWs of some fixed length [symbol] is denoted by n_{SAW}. To understand how n_{SAW} grows with [symbol] , first consider growing a walk on a square lattice by appending edges in some dimension D. Larger D means more directions to choose every time an edge is appended, so results in faster exponential growth of the number of walks. For walks of length [symbol] , one bound is that:

$$Equation 37$$

$${n}_{SAW} ( ℓ ) \leq {( 2 D - 1 )}^{ℓ}$$

as each new edge can be appended in any available direction other than back onto the walk itself. The dimension then directly affects the threshold, as the faster that n_{saw}( [symbol] ) blows up, the smaller the critical value of the error probabilities p must be to control the growth of error chains and suppress the magnitude of P_{fail} as the system size scales (as seen in Equation 41).

In this case, one needs to count the number of walks as a function of γ_{S} and the number of ways to insert bulk excursion segments hopping off and on the seam. For walks with γ_{S} seam edges there are

$$( \begin{matrix}{γ}_{S} \\ C\end{matrix} )$$

ways to choose C locations (indexed by k) along the length of the walk to insert “excursions,” each of length [symbol] , where the walk jumps off the seam and into the bulk before rejoining the seam. The excursion segments [symbol] , indexed from k=1 to C, together with bulk segments of length [symbol] and [symbol] ₋₁ at the beginning and end of the walk (if the walk starts or ends in the bulk instead of on the seam) form a set

$${\{ {ℓ}_{k} \}}_{k = 0}^{C + 1}$$

which will be denoted as just { [symbol] }. Once the locations of the corners are fixed along the length of the walk, they partition the walk into segments moving either in the bulk (dimension D_{b}) or seam (dimension Dₛ). The two “corner” bulk edges are separately counted, which project orthogonally from the seam at the beginning and end of each excursion, so that the total number of bulk edges resulting from the C excursions is then

$${γ}_{B} ≡ 2 C + {\sum }_{k = 0}^{C + 1} {ℓ}_{k} .$$

Now, for a fixed partitioning of the walk into seam and bulk segments with γ_{S}, C, { [symbol] }, one can follow the length of the walk and count the number of directions available in which to append edges when extending the walk in the seam or bulk as well as when encountering corners. When appending edges confined to the seam or during bulk excursions, μs=2Dₛ−1 or μ_{b}≡2D_{b}−1 options. Each of the C times the chain leaves the seam, there are 2(D_{b}−D_{S}) corner edges to choose, and each of the C times the chain moves back onto the seam from a corner, there are 2Dₛ options to choose the first seam edge of each seam segment (replacing the μs for those particular edges), so each excursion yields

$$2 ( {D}_{b} - {D}_{s} ) \times ( \frac{2 {D}_{s}}{{μ}_{s}} )$$

options, giving the overall bound when C≥1 and both seam and bulk edges are present:

$$Equation 38$$

$${n}_{SAW} ( {γ}_{S} , \{ {ℓ}_{k} \} , C \geq 1 ) \leq ( \begin{matrix}{γ}_{S} \\ C\end{matrix} ) {a}^{C} {μ}_{s}^{{γ}_{S}} {μ}_{b}^{{\sum }_{k} {ℓ}_{k}}$$

$$where a ≡ \frac{{μ}_{c}}{{μ}_{s}} and {μ}_{c} ≡ 4 {D}_{s} ( {D}_{b} - {D}_{s} )$$

counts the number of ways to choose the two corner edges at the beginning and end of each excursion. For

$${D}_{s} = 2 , {D}_{b} = 3 , {μ}_{s} = 3 , {μ}_{b} = 5 and a = \frac{8}{3} .$$

Only slightly smaller values than this simple counting argument for μₛ, μ_{b} are known.

If C=0, there is no SAW with both seam and bulk edges and the walk is only in either bulk or seam so S=0 or B=0:

$$Equation 39$$

$${n}_{SAW} ( {γ}_{S} , \vert \{ {ℓ}_{k} \} \vert = 0 , C = 0 ) \leq {μ}_{s}^{{γ}_{S}}$$

$${n}_{SAW} ( {γ}_{S} = 0 , \{ {ℓ}_{k} \} , C = 0 ) \leq {μ}_{b}^{{γ}_{B}}$$

### Bounding the Logical Failure Probability

Let Prob_{SAW}(γ_{S}, { [symbol] }, C) be the total probability to generate an error set {E} such that any {γ} with numbers of edges γ_{S}, { [symbol] }, and C is contained in {E+R}. As all {γ} with the same γ_{S}, { [symbol] }, C occur with the same probability bound given by Equation 35, one can express Prob_{SAW}(γ_{S}, { [symbol] }, C) as the probability from Equation 35 times the number of such walks n_{SAW}(γ_{S}, { [symbol] }, C). As there are poly(L) possible edges to start the walk in the matching graph:

$$Equation 40$$

$${Prob}_{SAW} ( {γ}_{S} , \{ {ℓ}_{k} \} , C ) / poly ( L ) \leq {n}_{SAW} ( {γ}_{S} , \{ {ℓ}_{k} \} , C ) \times {2}^{{γ}_{S} + [ 2 C + {\sum }_{k} {ℓ}_{k} ]} {p}_{s}^{{γ}_{S} / 2} {p}_{b}^{[ 2 C + {\sum }_{k} {ℓ}_{k} ] / 2}$$

Then one can bound the logical failure probability P_{fail}, since forming homologically non-trivial loops requires error chain walks with at least L edges stretching in the space or time direction along the seam so that the number of combined seam and bulk excursion edges is sufficiently large:

$${γ}_{S} + {\sum }_{k = 0}^{C + 1} {ℓ}_{k} \geq L .$$

Corner edges themselves do not contribute to generating walks along a direction necessary for failure. Summing over all the walks with values of γ_{S}, { [symbol] }, C which could contribute to logical failure gives:

$$Equation 41$$

$${P}_{fail} / poly ( L ) \leq {\sum }_{{γ}_{S} \geq 0} {\sum }_{C = 0}^{{γ}_{S}} {\sum }_{{\{ {ℓ}_{k} \geq 1 \} :}_{{γ}_{S} + {\sum }_{k} {ℓ}_{k} \geq L}} {Prob}_{SAW} ( {γ}_{S} , C , \{ {ℓ}_{k} \} ) \leq {\sum }_{{γ}_{S} \geq 0} {\sum }_{C = 0}^{{γ}_{S}} {\sum }_{{\{ {ℓ}_{k} \geq 1 \} :}_{{γ}_{S} + {\sum }_{k} {ℓ}_{k} \geq L}} {n}_{SAW} ( {γ}_{S} , C , \{ {ℓ}_{k} \} ) \times {( 4 {p}_{s} )}^{{γ}_{S} / 2} {( 4 {p}_{b} )}^{\frac{1}{2} {\sum }_{k} {ℓ}_{k}} {( 4 {p}_{b} )}^{C}$$

Plugging in expressions Equation 38 and Equation 39 for n_{SAW} into Equation 41 yields terms corresponding to purely bulk chains (S=0) and purely seam chains (B=0), with an additional sum over walks across the seam and bulk when there is at least one excursion C:

$$Equation 42$$

$${P}_{fail} / poly ( L ) \leq {\sum }_{{γ}_{S} \geq L} {( \frac{{p}_{s}}{{p}_{s}^{*}} )}^{\frac{{γ}_{S}}{2}} + {\sum }_{{γ}_{B} \geq L} {( \frac{{p}_{b}}{{p}_{b}^{*}} )}^{\frac{{γ}_{B}}{2}} + {\sum }_{{γ}_{S} \geq 1} {( \frac{{p}_{s}}{{p}_{s}^{*}} )}^{\frac{{γ}_{S}}{2}} {\sum }_{C = 1}^{{γ}_{S}} ( \begin{matrix}{γ}_{S} \\ C\end{matrix} ) {( 4 {ap}_{b} )}^{C} {\sum }_{{\{ {ℓ}_{k} \geq 1 \} :}_{{γ}_{S} + {\sum }_{k} {ℓ}_{k} \geq L}} {( \frac{{p}_{b}}{{p}_{b}^{*}} )}^{\frac{1}{2} {\sum }_{k} {ℓ}_{k}}$$

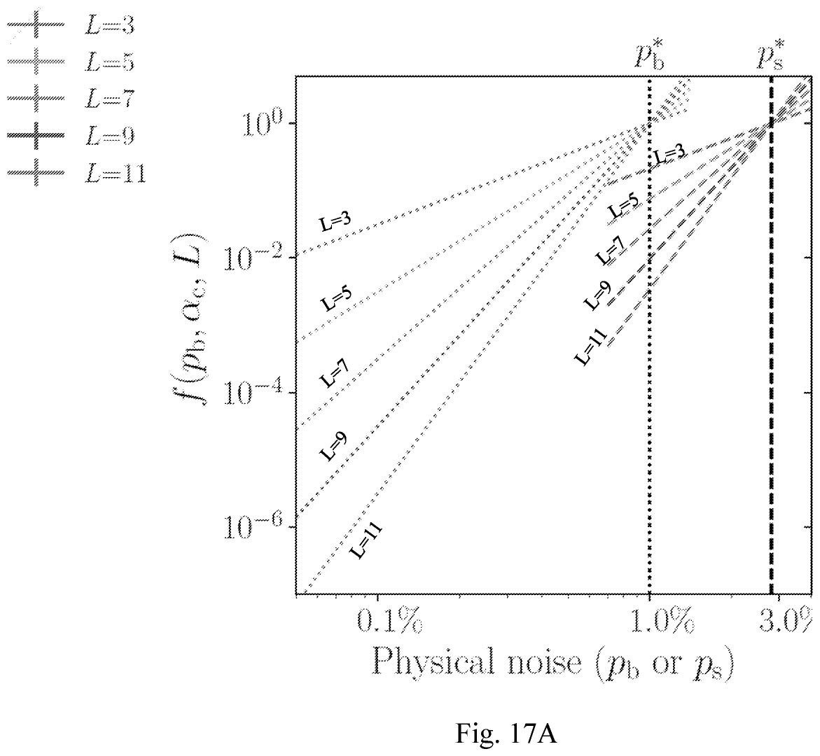

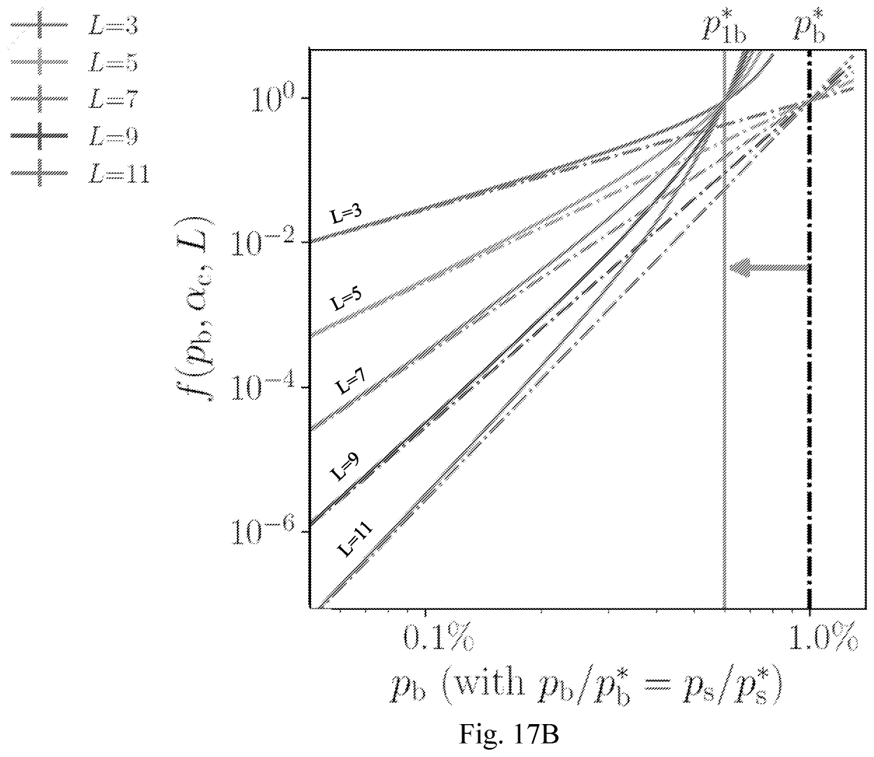

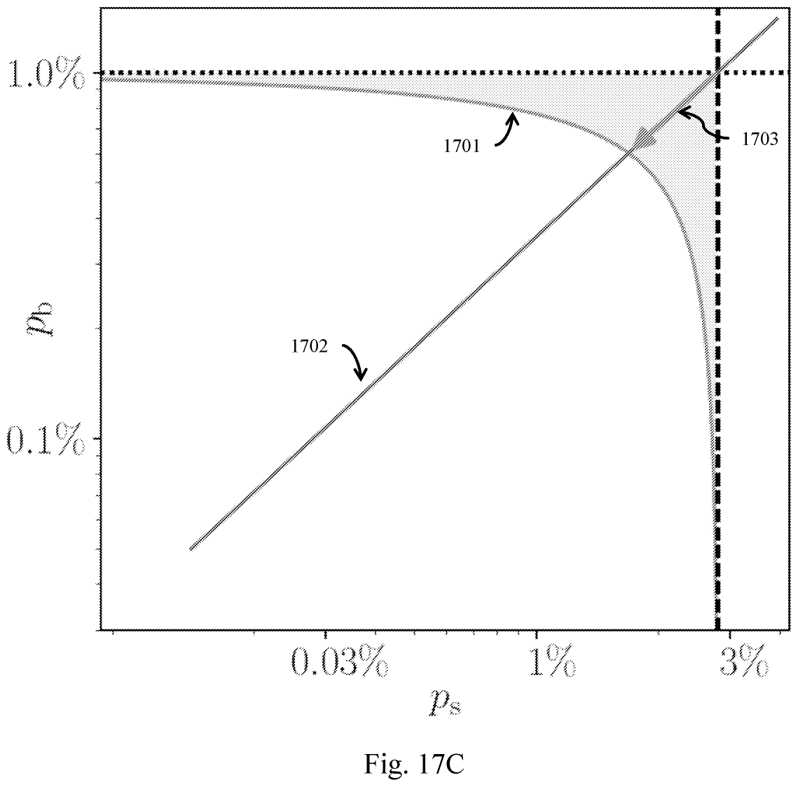

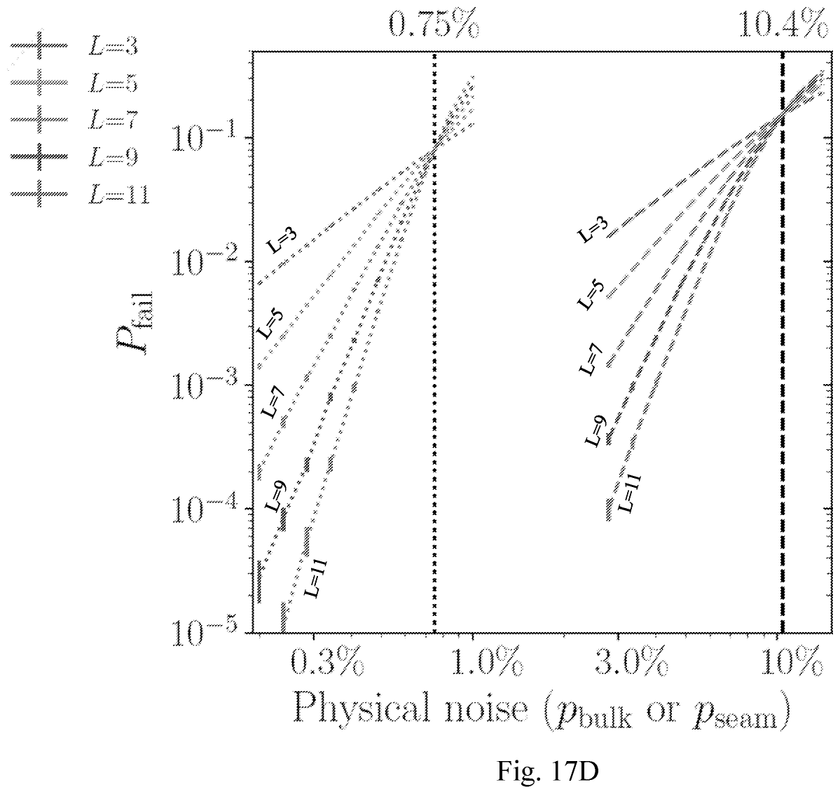

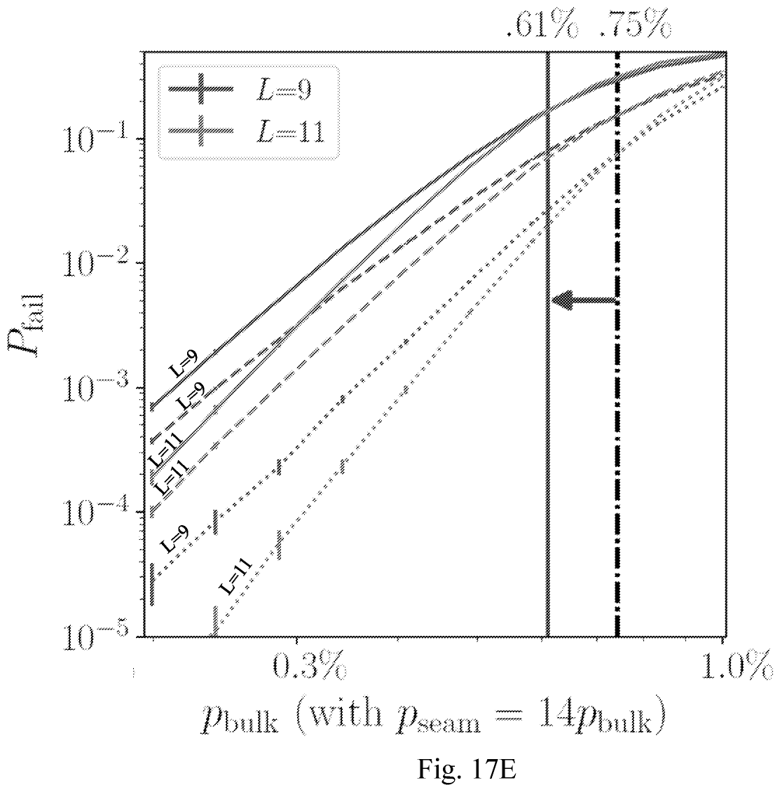

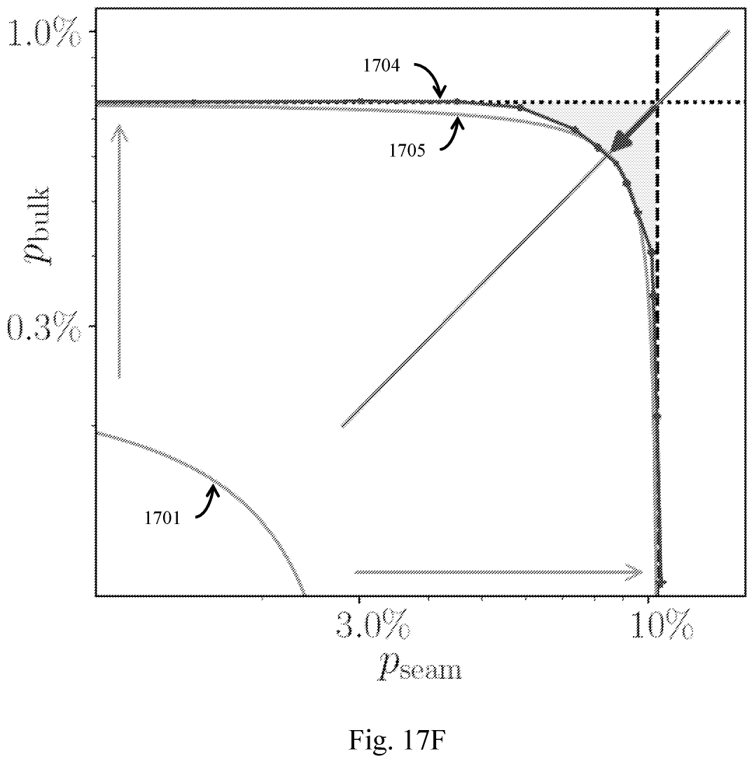

correspond to bounds on the thresholds for the seam and bulk when treated independently as in FIG. 17A. For the case of interest where

$${D}_{s} = 2 , {D}_{b} = 3 , {p}_{s}^{*} ≡ \frac{1}{4 {μ}_{s}^{2}} = \frac{1}{4 \times {3}^{2}} = 0.028 , {p}_{b}^{*} ≡ \frac{1}{4 {μ}_{b}^{2}} = \frac{1}{4 \times {5}^{2}} = 0.01$$

### (see FIG. 17A).

Now one can use the constraint [symbol] ₖ≥L−γ_{S} to realize that these geometric sums cannot all start at lₖ=1 when γ_{S}<L. It is denoted that they start at some dₖ such that Σₖdₖ≡L−γ_{S} for L−γ_{S}>0 and Σₖdₖ≡0 for L−γ_{S} [symbol] 0 (which is denoted as

$${{\sum }_{k} {d}_{k} ≡ L - {γ}_{S} \vert}_{> 0} ) and then {l}_{k} = {ℓ}_{k}^{′} + {d}_{k}$$

is substituted so that

$${l}_{k}^{′}$$

now represents the length of the “slack” in the chain at each excursion:

$${\sum }_{{\{ {ℓ}_{k} \geq 1 \} :}_{{γ}_{S} + {\sum }_{k} {ℓ}_{k} \geq L}} {( \frac{{p}_{b}}{{p}_{b}^{*}} )}^{\frac{1}{2} {\sum }_{k} {ℓ}_{k}} = {\sum }_{\{ {ℓ}_{k}^{′} \geq 0 \}} {( \frac{{p}_{b}}{{p}_{b}^{*}} )}^{\frac{1}{2} {\sum }_{k} {d}_{k} + {ℓ}_{k}^{′}} = {( \frac{{p}_{b}}{{p}_{b}^{*}} )}^{{\frac{L - {γ}_{S}}{2} \vert}_{> 0}} {\sum }_{\{ {ℓ}_{k}^{′} \geq 0 \}} {( \frac{{p}_{b}}{{p}_{b}^{*}} )}^{\frac{1}{2} {\sum }_{k} {ℓ}_{k}^{′}} \qquad Equation 43$$

where the same substitution transforms the constraint γ_{S}+ [symbol] ₖ≥L→γ_{S}+ [symbol] _{k′}+Σₖdₖ≥ [symbol] _{k′}≥0 (using Σₖdₖ=L−γ_{S}|_{≥0}), which is then trivial and dropped. For simplicity the l_{k′} is relabeled as just lₖ again.

The true upper limit on the sum would be determined when the volume of the bulk was filled by the excursions, so up to the constraint [symbol] ₖ≤poly(L). Then it is also the case that a bound can be maintained by extending the sum up to the constraint lₖ≤poly(L) for each [symbol] . Recall the definition of the notation

$$\{ {ℓ}_{k} \} = {\{ {ℓ}_{k} \}}_{k = 0}^{C + 1} .$$

One can then separate out the sums over the chain segment lengths of [symbol] and

$${ℓ}_{C + 1} , as for \frac{{p}_{b}}{{p}_{b}^{*}} < 1$$

it is then the case that

$${\sum }_{{ℓ}_{0} \geq 0}^{poly ( L )} {( \frac{{p}_{b}}{{p}_{b}^{*}} )}^{{ℓ}_{0} / 2} \leq poly ( L ) and {\sum }_{{ℓ}_{C + 1} \geq 0}^{poly ( L )} {( \frac{{p}_{b}}{{p}_{b}^{*}} )}^{{ℓ}_{C + 1} / 2} \leq poly ( L )$$

since all terms in the sum are less than 1, and this can be absorbed into P_{fail}/poly(L). Now, the remaining set of sections { [symbol] } runs from k=1 to C. Intuitively, since the bulk segments of length [symbol] and [symbol] ₊₁ at the beginning and end of the error chain each only occur once, they do not affect the threshold bound, whereas the number C of possible seam excursions in the middle of the error chain can scale with the system size, and so will affect the threshold.

To deal with the excursions, one can simplify and further maintain a bound by extending the upper limit to allow each lₖ to run up to co independently:

$${{\sum }^{poly ( L )}}_{{\{ {ℓ}_{k} \geq 0 \}}_{k = 1}^{C}} {( \frac{{p}_{b}}{{p}_{b}^{*}} )}^{\frac{1}{2} {\sum }_{k} {ℓ}_{k}} \leq {{\sum }^{∞}}_{{\{ {ℓ}_{k} \geq 0 \}}_{k = 1}^{C}} {( \frac{{p}_{b}}{{p}_{b}^{*}} )}^{\frac{1}{2} {\sum }_{k} {ℓ}_{k}}$$

Next, one can factor out the sum across the set of values

$${\{ {ℓ}_{k} \}}_{k = 1}^{C}$$

into a product and use the geometric sum

$${\sum }_{n = 0}^{∞} {r}^{n} = \frac{1}{1 - r} assuming \frac{{p}_{b}}{{p}_{b}^{*}} < 1 :$$

$${{\sum }^{∞}}_{{\{ {ℓ}_{k} \geq 0 \}}_{k = 1}^{C}} {( \frac{{p}_{b}}{{p}_{b}^{*}} )}^{\frac{1}{2} {\sum }_{k} {ℓ}_{k}} = {{\prod }_{k = 1}}^{C} [ {\sum }_{{ℓ}_{k} = 0}^{∞} {( \frac{{p}_{b}}{{p}_{b}^{*}} )}^{\frac{1}{2} {ℓ}_{k}} ] = {[ {\sum }_{ℓ = 0}^{∞} {( \frac{{p}_{b}}{{p}_{b}^{*}} )}^{\frac{1}{2} ℓ} ]}^{C} = {[ \frac{1}{1 - \sqrt{{p}_{b} / {p}_{b}^{*}}} ]}^{C} \qquad Equation 45$$

Substituting this into Equation 42 yields:

$${P}_{fail} / poly ( L ) \leq {\sum }_{{γ}_{S} \geq L} {( \frac{{p}_{s}}{{p}_{s}^{*}} )}^{\frac{{γ}_{S}}{2}} + {\sum }_{{γ}_{B} \geq L} {( \frac{{p}_{b}}{{p}_{b}^{*}} )}^{\frac{{γ}_{B}}{2}} + {\sum }_{{γ}_{S} \geq 1} {( \frac{{p}_{s}}{{p}_{s}^{*}} )}^{{γ}_{S} / 2} {( \frac{{p}_{b}}{{p}_{b}^{*}} )}^{{\frac{L - {γ}_{S}}{2} \vert}_{> 0}} \times {\sum }_{C = 1}^{{γ}_{S}} ( \begin{matrix}{γ}_{S} \\ C\end{matrix} ) {{( 4 {ap}_{b} )}^{C} [ \frac{1}{1 - \sqrt{{p}_{b} / {p}_{b}^{*}}} ]}^{C} \qquad Equation 46$$

Now one can use the identity

$${\sum }_{i = 0}^{n} ( \begin{matrix}n \\ i\end{matrix} ) {x}^{i} :$$

$${P}_{fail} / poly ( L ) \leq {\sum }_{{γ}_{S} \geq L} {( \frac{{p}_{s}}{{p}_{s}^{*}} )}^{\frac{{γ}_{S}}{2}} + {\sum }_{{γ}_{B} \geq L} {( \frac{{p}_{b}}{{p}_{b}^{*}} )}^{\frac{{γ}_{B}}{2}} + {\sum }_{{{γ}_{S} \geq 1 :}_{C \neq 0}} {( \frac{{p}_{s}}{{p}_{s}^{*}} )}^{\frac{{γ}_{S}}{2}} {{( \frac{{p}_{b}}{{p}_{b}^{*}} )}^{{\frac{L - {γ}_{S}}{2} \vert}_{> 0}} [ 1 + {a}_{c} {p}_{b} \frac{\sqrt{{p}_{s}^{*}}}{1 - \sqrt{{p}_{b} / {p}_{b}^{*}}} ]}^{{γ}_{S}} \qquad Equation 47$$

$$where 4 a = {α}_{c} \sqrt{{p}_{s}^{*}} ,$$

where α_{c} is effectively counting the number of ways to leave and return to the seam on a particular excursion.

Now, if there are no excursions C=0:

$${P}_{fail} ( C = 0 ) / poly ( L ) \leq {\sum }_{{γ}_{S} \geq L} {( \frac{{p}_{s}}{{p}_{s}^{*}} )}^{\frac{{γ}_{S}}{2}} + {\sum }_{{γ}_{B} \geq L} {( \frac{{p}_{b}}{{p}_{b}^{*}} )}^{\frac{{γ}_{B}}{2}} \qquad Equation 48$$

$$Now , for \frac{{p}_{s}}{{p}_{s}^{*}} < 1 , \frac{{p}_{b}}{{p}_{b}^{*}} < 1 ,$$

the largest terms in the sums of γ_{S}, γ_{B} will be the ones where γ_{S}=L and γ_{B}=L, and as the sums can only have at maximum a number of terms equal to lattice size, some poly(L), yielding:

$$Equation 49$$

$${P}_{fail} ( C = 0 ) / poly ( L ) \leq {( \frac{{p}_{s}}{{p}_{s}^{*}} )}^{\frac{L}{2}} + {( \frac{{p}_{b}}{{p}_{b}^{*}} )}^{\frac{L}{2}}$$

A similar argument applies to the cross terms:

$$Equation 50$$

$${P}_{fail} / poly ( L ) \leq {( \frac{{p}_{s}}{{p}_{s}^{*}} )}^{\frac{L}{2}} + {( \frac{{p}_{b}}{{p}_{b}^{*}} )}^{\frac{L}{2}} + {{\sum }_{{γ}_{S} \geq 1 :}^{L}}_{C \neq 0} {[ \frac{{p}_{s}}{{p}_{s}^{*}} {( 1 + {α}_{c} {p}_{b} \frac{\sqrt{{p}_{s}^{*}}}{1 - \sqrt{{p}_{b} / {p}_{b}^{*}}} )}^{2} ]}^{\frac{{γ}_{S}}{2}} {( \frac{{p}_{b}}{{p}_{b}^{*}} )}^{\frac{L - {γ}_{S}}{2}}$$

which are all suppressed as L≤∞ provided that

$$Equation 51$$

$${\frac{{p}_{s}}{{p}_{s}^{*}} [ 1 + {α}_{c} {p}_{b} \frac{\sqrt{{p}_{s}^{*}}}{1 - \sqrt{{p}_{b} / {p}_{b}^{*}}} ]}^{2} < 1$$

$$Equation 52$$

$$\frac{{p}_{b}}{{p}_{b}^{*}} < 1$$

Re-expressing Equation 51, one can see that it is equivalent to a small downward “sag” of the threshold bound:

$$Equation 53$$

$${p}_{s}^{*} \to {p}_{1 s}^{*} ≡ {p}_{s}^{*} / {[ 1 + {α}_{c} {p}_{b} \frac{\sqrt{{p}_{s}^{*}}}{1 - \sqrt{{p}_{b} / {p}_{b}^{*}}} ]}^{2}$$

demonstrating a tradeoff between different amounts of “sag” in the seam and bulk thresholds when both seam and bulk errors are occurring (see FIG. 17C).

Specializing to the case

$$\frac{{p}_{s}}{{p}_{s}^{*}} = \frac{{p}_{b}}{{p}_{b}^{*}}$$

one can further bound and simplify, which is plotted in FIG. 17B and compared to numerical simulations:

$$Equation 54$$

$${P}_{fail} / poly ( L ) \leq {[ \frac{{p}_{b}}{{p}_{b}^{*}} {( 1 + {α}_{c} {p}_{b} \frac{\sqrt{{p}_{s}^{*}}}{1 - \sqrt{{p}_{b} / {p}_{b}^{*}}} )}^{2} ]}^{\frac{L}{2}} ≡ f ( {p}_{b} , {α}_{c} , L )$$

Equation 54 suggests not only what combinations of seam and bulk errors achieve a threshold but also, importantly for determining the scaling efficiency, that the subthreshold behavior quickly approaches that of independent bulk and seam when the bulk itself is subthreshold. From the numbers above, one can see that with p_{b} just a few times below

$${p}_{b}^{*} ,$$

excursions from the seam into the bulk are strongly suppressed, so that the subthreshold scaling of the seam terms in Equation 50 is nearly the same as without any bulk errors. Indeed, one can see behavior consistent with this observation in the numerical results in FIG. 17E, with the curves for combined seam and bulk errors approaching those for purely seam errors once a few times below threshold.

Referring to FIGS. 17A-C, analytical logical failure bounds are shown. FIG. 17A shows bounds for D_{b}=3 (dotted) and Dₛ=2 (dashed), with threshold bounds

$${p}_{b}^{*} and {p}_{s}^{*}$$

respectively. FIG. 17B shows analytical bounds (Equation 54) fixing

$$\frac{{p}_{b}}{{p}_{b}^{*}} = \frac{{p}_{s}}{{p}_{s}^{*}}$$

(solid), in which case the seam and bulk curves from FIG. 17A now overlap (dot-dashed) and are plotted VS p_{b}. Seam-bulk interactions reduce the threshold bound slightly to

$${p}_{1 b}^{*}$$

as indicated by arrow 1703. The logical failure rate converges to the values for no seam-bulk interactions once a few times below threshold as excursions into the bulk become “frozen out.” FIG. 17C plots the threshold bound Equation 51 (1701) in the space of possible choices for pₛ, p_{b}. In the absence of seam-bulk interactions, all points to the left of the dashed line

$$( so {p}_{b} < {p}_{b}^{*}$$

and below the dotted line

$$( so {p}_{b} < {p}_{b}^{*} )$$

would be below the threshold bound. Seam-bulk interactions make the threshold bound sag to curve 1701, where the gray region is no longer below the threshold bound. Line 1702 shows the cut corresponding to the horizontal axis from FIG. 17B.

Referring to FIGS. 17D-F, numerical simulations are shown. FIG. 17D provides the same view as FIG. 17A but with exact numerical simulation. FIG. 17E provides the same view as FIG. 17B for L-9 and 11, but with exact numerical simulation with the choice pₛₑₐₘ=14p_{bulk}, approximately

$$\frac{{p}_{bulk}}{{p}_{bulk}^{*}} = \frac{{p}_{seam}}{{p}_{seam}^{*}} .$$

Curves including seam-bulk interaction (solid) similarly converge toward the seam-only curves (dashed) as

$$\frac{{p}_{bulk}}{{p}_{bulk}^{*}}$$

becomes small. Bulk-only curves are dotted. FIG. 17F shows numerically extracted threshold plotted in terms of pₛₑₐₘ, p_{bulk} (1704). Curve 1701 is the bound replotted from FIG. 17C. Curve 1705 shows the bound with numerically extracted thresholds substituted in along with an effective value of α_{c}≤1.4, the minimal value which still bounds all the numerical datapoints.

### Extending the Model to 2 Seams

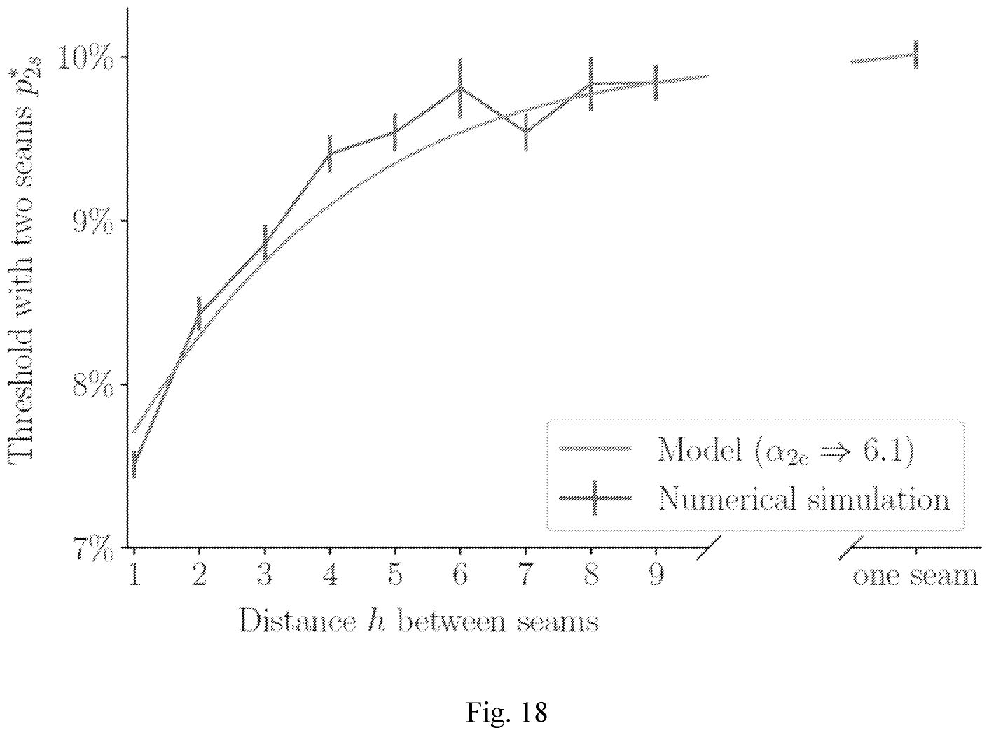

By adding multiple seams along space and/or time directions and counting the paths to hop between different seams, this formalism can be used to understand situations including repeated transversal gates and code patches spanning multiple modules. As an illustration, in FIG. 18 it is simulated how having two parallel Dₛ=2 seams nearby within the same D_{b}=3 bulk leads to additional threshold sag. In this formalism, one can capture this additional sag by adding terms representing paths hopping between opposite seams, from which can be understood that the additional sag disappears for larger h since longer hops which traverse further through the bulk are suppressed in probability.

In this section, these approaches are generalized to understand the case of having these two seams embedded in the same bulk, where error chains can now hop between seams in addition to hopping off and on the same seam. One can interpret the results from the previous section in the following way. Increasing γ_{S} by 1 to append an additional seam edge leads to an additional factor of:

$$Equation 55$$

$$\sqrt{\frac{{p}_{s}}{{p}_{s}^{*}}} [ 1 + {α}_{c} {p}_{b} \frac{\sqrt{{p}_{s}^{*}}}{1 - \sqrt{{p}_{b} / {p}_{b}^{*}}} ]$$

where this factor must be smaller than unity to be below threshold. To interpret these results, one can rewrite the factor from above:

$$Equation 56$$

$$\begin{matrix}= {μ}_{s} \sqrt{4 {p}_{s}} + {μ}_{c} \sqrt{4 {p}_{s}} {( \sqrt{4 {p}_{b}} )}^{2} \frac{1}{1 - \sqrt{{p}_{b} / {p}_{b}^{*}}} \\ = {μ}_{s} \sqrt{4 {p}_{s}} + {μ}_{c} \sqrt{4 {p}_{s}} {( \sqrt{4 {p}_{b}} )}^{2} {\sum }_{ℓ = 0}^{∞} {( \frac{{p}_{b}}{{p}_{b}^{*}} )}^{ℓ / 2} \\ = {μ}_{s} \sqrt{4 {p}_{s}} + {μ}_{c} \sqrt{4 {p}_{s}} {( \sqrt{4 {p}_{b}} )}^{2} {\sum }_{ℓ = 0}^{∞} {( {μ}_{b} \sqrt{4 {p}_{b}} )}^{ℓ}\end{matrix}$$

One can interpret this factor as a sum across the different possible ways to append the next seam edge, weighted by the “probabilities” associated with each edge (in fact the square roots of the “probabilities” because of the argument from above where MWPM can fill in missing edges). The next seam edge can be added either by remaining on the seam and locally appending another seam edge (\sqrt{4pₛ} with μₛ options), or by first jumping out into the bulk, appending [symbol] bulk edges, and then reattaching back onto the seam (\sqrt{4pₛ}(\sqrt{4p_{b}})² with μ_{c} ways to establish the beginning and end points of the seam and summed over all ways to have k bulk edges in the middle of the excursion).

This kind of approach is helpful to understand not only how excursions from a single seam back onto itself behave, but also other situations, such as when one has multiple seams within a code. For example, when there are two seams it would make sense to consider additional terms to the sum above to account for excursions which hop between seams in addition to hopping off/on the same seam. In that case, one can qualitatively add a term corresponding to all the paths which leave one of the seams and rejoin the opposite seam:

$$Equation 57$$

$$( {μ}_{2 c} \sqrt{4 {p}_{s}} {\sqrt{4 {p}_{b}}}^{2} ) {\sum }_{ℓ = h - 2}^{∞} {( {μ}_{b} \sqrt{4 {p}_{b}} )}^{ℓ}$$

appending chains of [symbol] bulk edges to hop between seams, where h is the distance separating the seams (and the sum is from h−2 because there have to be at least that many bulk edges in addition to the corner edges to stretch between the seams), and μ_{2c} is the number of ways to leave one seam and rejoin the second (μ_{2c}=4 is a reasonable choice since these paths would be dominated by ones which leave in the direction toward the other seam, so one choice to leave and 4 to rejoin). This yields the total sum:

$$Equation 58$$

$${μ}_{s} \sqrt{4 {p}_{s}} + ( {μ}_{c} \sqrt{4 {p}_{s}} {\sqrt{4 {p}_{b}}}^{2} ) {\sum }_{ℓ = 0}^{∞} {( {μ}_{b} \sqrt{4 {p}_{b}} )}^{ℓ} + ( {μ}_{2 c} \sqrt{4 {p}_{s}} {\sqrt{4 {p}_{b}}}^{2} ) {\sum }_{ℓ = h - 2}^{∞} {( {μ}_{b} \sqrt{4 {p}_{b}} )}^{ℓ}$$

As was done in the previous section, one can collapse the threshold shift due to a single seam:

$${p}_{s}^{*} \to {p}_{1 s}^{*}$$

and then have only the interseam hops separated out:

$$\sqrt{\frac{{p}_{s}}{{p}_{1 s}^{*}}} + {μ}_{2 c} \sqrt{4 {p}_{s}} {\sqrt{4 {p}_{b}}}^{2} {\sum }_{ℓ = h - 2}^{∞} {( {μ}_{b} \sqrt{4 {p}_{b}} )}^{ℓ} = \sqrt{\frac{{p}_{s}}{{p}_{1 s}^{*}}} [ 1 + {α}_{2 c} \sqrt{{p}_{1 s}^{*}} {\sqrt{{p}_{b}}}^{2} {( \frac{{p}_{b}}{{p}_{b}^{*}} )}^{( h - 2 ) / 2} \frac{1}{1 - \sqrt{{p}_{b} / {p}_{b}^{*}}} ] \qquad Equation 59$$

$$with {α}_{2 c} ≡ 8 {μ}_{2 c} .$$

Like before, one can move the whole term in brackets down against

$${p}_{1 s}^{*}$$

to find the form of the expected additional threshold shift due to hops between seams:

$${p}_{1 s}^{*} \to {p}_{2 s}^{*} ≡ {p}_{1 s}^{*} {/ [ 1 + {α}_{2 c} {p}_{b} \frac{\sqrt{{p}_{1 s}^{*}}}{1 - \sqrt{{p}_{b} / {p}_{b}^{*}}} {( \frac{{p}_{b}}{{p}_{b}^{*}} )}^{( h - 2 ) / 2} ]}^{2} \qquad Equation 60$$

The extra threshold shift here disappears for large h; long hops through the bulk between seams are then highly suppressed and become a negligible contributor to the ways to add the next seam edge.

Choosing for example

$$\frac{{p}_{b}}{{p}_{b}^{*}} \to \frac{1}{2} ,$$

one can see that there is only a slight drop in the seam error threshold due to having the bulk surrounding a single seam. Setting

$${p}_{1 s}^{*}$$

to this value, in FIG. 18 Equation 60 is plotted for an effective value of α_2c=6.1, which then closely matches the behavior of the numerically extracted seam error threshold for 2 seams. The analytical formulas appear to capture the qualitative relationship between the distance between seams and how far below threshold the bulk is, and can easily be generalized to cases of having many seams and in higher dimensions, such as building a large surface code from smaller patches.

Referring to FIG. 18, the effect on the threshold due to two nearby parallel seams is plotted, fixing

$$\frac{{p}_{b}}{{p}_{b}^{*}} = \frac{1}{2}$$

The results of numerical simulation are shown in solid line with crosses. The walk counting model plotted with fit value α_{2c}=6.1 is shown in solid line without crosses. The closer the seams (smaller h), the easier it is to hop between seams, lowering the threshold. For large h, long excursions into the bulk are exponentially suppressed and the threshold returns to the value for just one seam.

### Microscopic Seam Error Model

Bell pairs and CNOT gates are each modeled as a perfect operation followed by all combinations of X, Y, Z errors on the two qubits, each with error □_{B}/15 or ϵ_{CS}/15: IX, IY, IZ, XI, XX, XY, XZ, YI, YX, YY, YZ, ZI, ZX, ZY, ZZ. As the Bell pair is stabilized under the application of XX, ZZ, all 15 types of errors are equivalent to II with

$$\frac{1}{s} {ϵ}_{B}$$

and IX, IY, or IZ with probability

$$\frac{4}{15} {ϵ}_{B} .$$

Similarly as Y∝XZ , one can count up the total probability a given qubit gets hit by X and by Z errors following a CNOT:

$$\frac{8}{15} {ϵ}_{CX} .$$

Using this error model, a standard surface code patch is considered. In this case, there is no seam, and errors only arise from CNOT gate errors and readout errors. As each data qubit is subject to four parity check operations per code cycle, the bit flip probability for data qubits is

$${p}_{bulk} = 4 \times \frac{8}{15} {ϵ}_{C X} \approx 2 {ϵ}_{C X} .$$

Similarly for syndrome qubits, but with an additional error associated with syndrome qubit readout,

$${q}_{bulk} = 4 \times \frac{8}{15} {ϵ}_{C X} + {ϵ}_{M} \approx 2 {ϵ}_{C X} + {ϵ}_{M} .$$

To determine the dependence of the logical error probability on the code distance and local gate errors, a Monte Carlo simulation of errors (p_{bulk} and q_{bulk}) and a local minimum weight perfect matching decoder is used, exhibiting a threshold of 1.3%.

Next, consider the situation where two surface code patches are being merged via teleported gates spanning the seam. Stretching the parity check operators across the seam involves one teleported gate per data/syndrome qubit pair on the seam. FIG. 2 shows how a teleported gate propagates bit and phase (X and Z) errors occurring on a Bell pair. Bit flip errors on the Bell pair propagate exclusively to the target qubit. Similarly, phase flip errors on the Bell pair propagate exclusively to the control qubit. In total, the bit flip probability on the control qubit is

$$\frac{8}{15} {ϵ}_{CX} ,$$

whereas the pit flip probability on the target is

$$\frac{8}{15} {ϵ}_{B} + 2 \times \frac{8}{15} {ϵ}_{C X} + {ϵ}_{M} .$$

Similarly, the phase flip probability on the control qubit

$$\frac{8}{15} {ϵ}_{B} + 2 \times \frac{8}{15} {ϵ}_{C X} + {ϵ}_{M} ,$$

whereas the phase flip probability on the target is

$$\frac{8}{15} {ϵ}_{CX} .$$

Per code cycle, each qubit along the seam experiences three local CNOTs followed by one teleported gate. As the seam shown in FIG. 1 is along the X_{L} direction, it is most susceptible to logical bit flip errors X_{L} arising from bit flips along the length of the seam, specifically on the seam qubits in code patch 2. In contrast, although phase flip errors are also occurring with elevated probability along the length of the vertical seam (specifically on the seam qubits in code patch 1), they contribute little to logical phase errors, which correspond to horizontal strings.

For qubits on the seam, the phenomenological weighted error model is as follows. A plaquette syndrome qubit on code patch (CP) 2 is the target of three local CNOTs

$$( 3 \times \frac{8}{15} {ϵ}_{CX} ) ,$$

as well as the target or one teleported gate

$$( \frac{8}{15} {ϵ}_{B} + 2 \times \frac{8}{15} {ϵ}_{CX} + {ϵ}_{M} )$$

and one final readout (ϵ_{M}). The resulting bit flip probability for a plaquette syndrome qubit in code patch 2 is

$${q}_{seam} = 3 \times \frac{8}{15} {ϵ}_{CX} + ( \frac{8}{15} {ϵ}_{B} + 2 \times \frac{8}{15} {ϵ}_{CX} + {ϵ}_{M} ) + {ϵ}_{M} \approx 0.5 {ϵ}_{B} + 2.5 {ϵ}_{CX} + 2 {ϵ}_{M} .$$

A data qubit on the seam of code patch 2 experiences identical bit flip probability to a plaquette syndrome qubit in the same patch, less one final readout,

$${p}_{seam} = 3 \times \frac{8}{15} {ϵ}_{CX} + ( \frac{8}{15} {ϵ}_{B} + 2 \times \frac{8}{15} {ϵ}_{CX} + {ϵ}_{M} ) + {ϵ}_{M} \approx 0.5 {ϵ}_{B} + 2.5 {ϵ}_{C X} + {ϵ}_{M} .$$

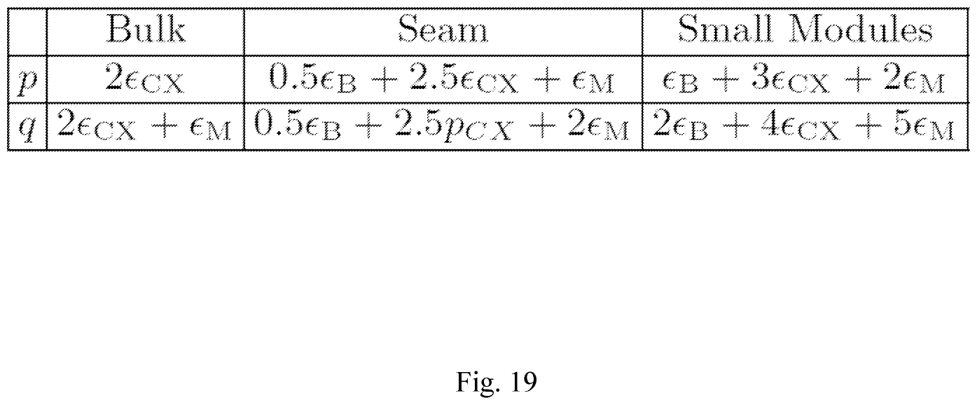

Additionally, data qubits in code patch 2 experience phase flip errors at the same rate as bulk qubits. Correspondingly, similar considerations apply to data and star syndrome qubits in code patch 1, which experience elevated levels of phase flip errors. FIG. 19 summarizes the noise.

### Small Modules Error Model

For comparison, in minimal-size module configuration, where each module contains a single data or syndrome qubit and just one communication qubit, teleported gates must be used for each two-qubit operation in all the check operators, leading to substantially worse performance.

Each code cycle, a given data qubit is the target of 2 teleported CNOTs and control of 2 teleported CNOTs, giving a bit flip probability per code cycle of

$${p}_{small} = 2 \times ( \frac{8 {ϵ}_{B}}{15} + 2 \times \frac{8 {ϵ}_{CX}}{15} + {ϵ}_{M} ) + 2 \times ( \frac{8 {ϵ}_{CX}}{15} ) \approx {ϵ}_{B} + 3 {ϵ}_{CX} + 2 {ϵ}_{M} .$$

Similarly, consider a plaquette syndrome qubit, which is the target of four teleported CNOTs, then followed with additional readout error ϵ_{M}. This plaquette has an error probability of

$${q}_{small} = 4 \times ( \frac{8 {ϵ}_{B}}{15} + 2 \times \frac{8 {ϵ}_{CX}}{15} + {ϵ}_{M} ) + {ϵ}_{M} \approx 2 {ϵ}_{B} + 4 {ϵ}_{CX} + 5 {ϵ}_{M} .$$

The result is the same for star operator syndrome qubits.

Also, since the threshold would occur at p=3% for q=p, expressing the threshold in terms of ϵ_{B} and ϵ_{CX} amounts to determining to what extent each of these contributes to p. In fact, taking for simplicity ϵ_{CX}=ϵ_{M} and averaging the Small Modules expressions for p and q from FIG. 19 gives a reasonable approximation for the threshold relationship 3%=1.5ϵ_{B}+7ϵ_{CX}. An exact simulation with the Small Modules weights for p and q gives results quite close to this.

FIG. 19 shows phenomenological bit flip error probabilities per code cycle p and q on data and syndrome qubits. Entries describe how, during a given code cycle, local operations and Bell pairs add to the total phenomenological error probability. Phase flip error rates are identical. “Bulk” and “Seam” columns correspond to regions depicted in FIG. 1, and for comparison, the “Small Modules” column shows the case where all gates in a surface code are done with teleported gates.

### Formation of Array of Particles Using Optical Tweezers

Optical trapping of neutral atoms is a powerful technique for isolating atoms in vacuum. Atoms are polarizable, and the oscillating electric field of a light beam induces an oscillating electric dipole moment in the atom. The associated energy shift in an atom from the induced dipole, averaged over a light oscillation period, is called the AC Stark shift. Based on the AC Stark shift induced by light that is detuned (i.e., offset in wavelength) from atomic resonance transitions, atoms are trapped at local intensity maxima (for red detuned, that is, longer wavelength trap light), because the atoms are attracted to light below the resonance frequency. The AC Stark shift is proportional to the intensity of the light. Thus, the shape of the intensity field is the shape of an associated atom trap. Optical tweezers utilize this principle by focusing a laser to a micron-scale waist, where individual atoms are trapped at the focus. Two-dimensional (2D) arrays of optical tweezers are generated by, for example, illuminating a spatial light modulator (SLM), which imprints a computer-generated hologram on the wavefront of the laser field. The 2D array of optical tweezers is overlapped with a cloud of laser-cooled atoms in a magneto-optical trap (MOT). The tightly focused optical tweezers operate in a “collisional blockade” regime, in which single atoms are loaded from the MOT, while pairs of atoms are ejected due to light-assisted collisions, ensuring that the tweezers are loaded with at most single atoms, but the loading is probabilistic, such that the trap is loaded with a single atom with a probability of about 50-60%.

To prepare deterministic atom arrays, a real-time feedback procedure identifies the randomly loaded atoms and rearranges them into pre-programmed geometries. Atom rearrangement requires moving atoms in tweezers which can be smoothly steered to minimize heating, by using, for example, acousto-optic deflectors (AODs) to deflect a laser beam by a tunable angle which is controlled by the frequency of an acoustic waveform applied to the AOD crystal. Dynamic tuning of the acoustic frequency translates into smooth motion of an optical tweezer. A multi-frequency acoustic wave creates an array of laser deflections, which, after focusing through a microscope objective, forms an array of optical tweezers with tunable position and amplitude that are both controlled by the acoustic waveform. Atoms are rearranged by using an additional set of dynamically moving tweezers that are overlaid on top of the SLM tweezer array.

Exemplary Hardware

Optical tweezer arrays constitute a powerful and flexible way to construct large scale systems composed of individual particles. Each optical tweezer traps a single particle, including, but not limited to, individual neutral atoms and molecules for applications in quantum technology. Loading individual particles into such tweezer arrays is a stochastic process, where each tweezer in the system is filled with a single particle with a finite probability p<1, for example p˜0.5 in the case of many neutral atom tweezer implementations. To compensate for this random loading, real-time feedback may be obtained by measuring which tweezers are loaded and then sorting the loaded particles into a programmable geometry. This may be performed by moving one particle at a time, or in parallel.

Parallel sorting may be achieved by using two acousto-optic deflectors (AODs) to generate multiple tweezers that can pick up particles from an existing particle-trapping structure, move them simultaneously, and release them somewhere else. This can include moving particles around within a single trapping structure (e.g., tweezer array) or transporting and sorting particles from one trapping system to another (e.g., between one tweezer array and another type of optical/magnetic trap). This sorting is flexible and allows programmed positioning of each particle. Each movable trap is formed by the AODs and its position is dynamically controlled by the frequency components of the radiofrequency (RF) drive field for the AODs. Since the RF drive of the AODs can be controlled in real time and can include any combination of frequency components, it is possible to generate any grid of traps (such as a line of arbitrarily positioned traps), move the rows or columns of the grid, and add or remove rows and columns of the grid, by changing the number, magnitude, and distribution of the frequency components in the RF drive fields of the AODs.

In an exemplary embodiment, an optical tweezer array is created using a liquid crystal on silicon spatial light modulator (SLM), which can programmatically create flexible arrangements of tweezers. These tweezers are fixed in space for a given experimental sequence and loaded stochastically with individual atoms, such that each tweezer is loaded with probability p˜0.5. A fluorescence image of the loaded atoms is taken, to identify in real-time which tweezers are loaded and which are empty.

After detecting which tweezers are loaded, movable tweezers overlapping the optical tweezer array can dynamically reposition atoms from their starting locations to fill a target arrangement of traps with near-unity filling. The movable tweezers are created with a pair of crossed AODs. These AODs can be used to create a single moveable trap which moves one atom at a time to fill the target arrangement or to move many atoms in parallel.

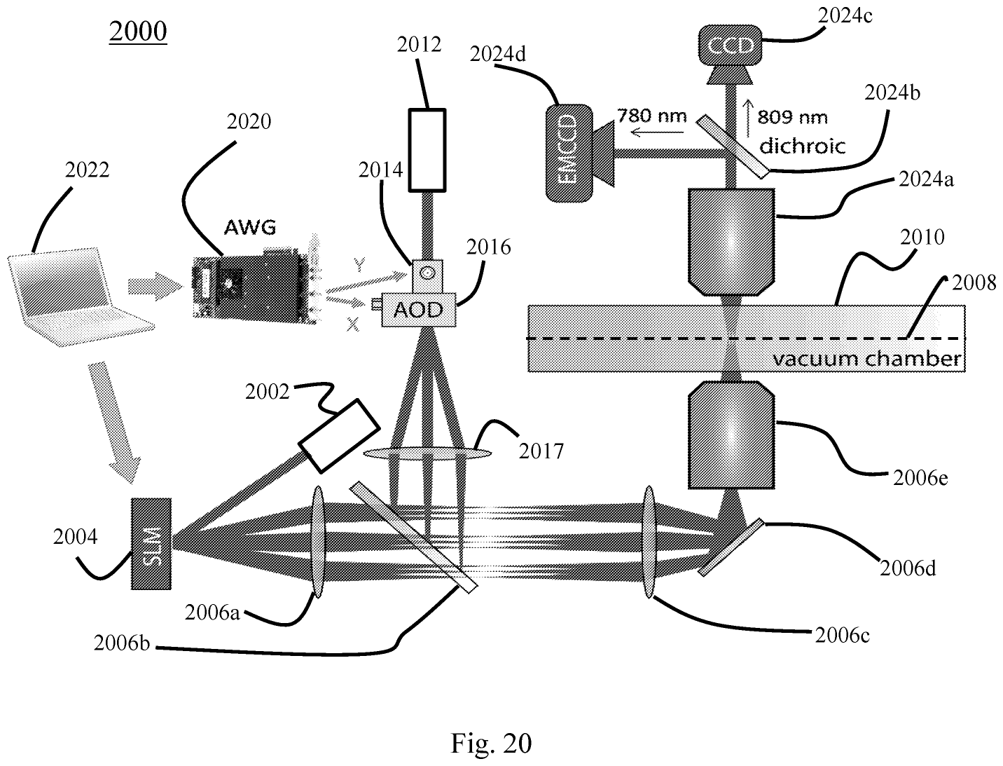

Referring to FIG. 20, a schematic view is provided of an apparatus 2000 for fault-tolerant quantum computation according to embodiments of the present disclosure. As shown in FIG. 20, using a beam generated by a light source 2002 (for example, a coherent light source, in some example embodiments—a monochromatic light source), SLM 2004 forms an array of trapping beams (i.e., a tweezer array) which is imaged onto trapping plane 2008 in vacuum chamber 2010 by an optical train that, in the example embodiment shown in FIG. 20, comprises elements 2006a, 2006c, 2006d, and a high numerical aperture (NA) objective 2006e. Other suitable optical trains can be employed, as would be easily recognized by a person of ordinary skill in the art. Using a beam generated by light source 2012 (for example, a coherent light source; in some example embodiments-a monochromatic light source), a pair of AODs 2014 and 2016, having non-parallel directions of acoustic wave propagation (for example, orthogonal directions) creates dynamically movable sorting beams. By using the optical train, such as the one depicted in FIG. 20 (elements 2017, 2006b, 2006c, 2006d, and 2006e), the sorting beams are overlapped with the trapping beams. It is understood that other optical train can be used to achieve the same result. For example, source 2002 and 2012 can be a single source, and the trapping beam and the sorting beam are generated by a beam splitter.

The dynamic movement of the steering beams is accomplished by employing two non-parallel AODs 2014, 2016, arranged in series. In the example embodiment depicted in FIG. 20, one AOD defines the direction of “rows” (“horizontal”—the ‘X’ AOD) and the other AOD defines the direction of “columns” (“vertical”—the ‘Y’ AOD). Each AOD is driven with an arbitrary RF waveform from an arbitrary waveform generator 2020, which is generated in real-time by a computer 2022 which processes the feedback routine after analyzing the image of where atoms are loaded. If each AOD is driven with a single frequency component, then a single steering beam (“AOD trap”) is created in the same plane 2008 as the SLM trap array. The frequency of the X AOD drive determines the horizontal position of the AOD trap, and the frequency of the Y AOD drive determines the vertical position; in this way, a single AOD trap can be steered to overlap with any SLM trap.

In FIG. 20, laser 2002 projects a beam of light onto SLM 2004. SLM 2004 can be controlled by computer 2022 in order to generate a pattern of beams (“trapping beams” or “tweezer array”). The pattern of beams is focused by lens 2006a, passes through mirror 2006b, and is collimates by lens 2006c on mirror 2006d. The reflected light passes through objective 2006e to focus an optical tweezer array in vacuum chamber 2010 on trapping plane 2008. The laser light of the optical tweezer array continues through objective 2024a, and passes through dichroic mirror 2024b to be detected by charge-coupled device (CCD) camera 2024c.

Vacuum chamber 2010 may be illuminated by an additional light source (not pictured). Fluorescence from atoms trapped on the trapping plane also passes through objective 2024a, but is reflected by dichroic mirror 2024b to electron-multiplying CCD (EMCCD) camera 2024d.

In this example, laser 2012 directs a beam of light to AODs 2014, 2016. AODs 2014, 2016 are driven by arbitrary wave generator (AWG) 2020, which is in turn controlled by computer 2022. Crossed AODs 2014, 2016 emit one or more beams as set forth above, which are directed to focusing lens 2017. The beams then enter the same optical train 2006b . . . 2006e as described above with regard to the optical tweezer array, focusing on trapping plane 2008.

It will be appreciated that alternative optical trains may be employed to produce an optical tweezer array suitable for use as set out herein.

Excitation of Atoms in Arrays of Optical Tweezers into Rydberg States

At the micrometer length scales separating optical tweezers, atoms in their ground electronic states have negligible van der Waals interactions. Fortunately, neutral atoms offer a remarkable way to switch on strong interactions through the coherent excitation of the atoms into Rydberg states.

The properties of atomic states scale dramatically with principal quantum number. Rydberg states are highly excited electronic states of the atoms, wherein one of the electrons of the atom has a high principal quantum number n in a range of between 30 and 100. In a classical picture of the atom, this situation corresponds to one (negatively charged) electron orbiting far away from the (positively charged) ionic core on atomic length scales, thus forming an oscillating electric dipole. Two atoms excited into the same Rydberg state can exhibit very strong dipolar interactions over distances of several tens of microns. The interaction energy V(R)=C₆/R⁶, where R is the interatomic distance, and the coefficient C₆ scales with a very large power law C₆∝n¹¹, with typical values of the interaction energy V(R) in a range of between several megahertz and several gigahertz for atoms that are separated by several microns. The interaction energy can be employed for a number of important applications, such as quantum entanglement and quantum gates, by implementation of a Rydberg blockade mechanism.

Consider an ideal two-level atom, having a ground state |g [symbol] and a Rydberg state |r [symbol] . These two states are laser-coupled with a coupling strength set by the angular Rabi frequency Ω, the inverse of the duration of a Rabi cycle, also referred to as a Rabi flop, that is the cyclic absorption and stimulated emission of a quantum of energy by a two-level atom in the presence of an oscillatory driving field. The Rabi frequency is proportional to the strength of the coupling between the light and the atomic transition, and to the amplitude of the light's electric field. For two such atoms, also referred to herein as Rydberg atoms, if their interatomic distance R is large, such that the van der Waals interaction energy V_{vdW} can be neglected compared to the laser coupling strength, that is V_{vdW}«hΩ (where h is the reduced Planck's constant), the atoms can be regarded as independent particles, and thus both can be excited to the Rydberg state at the same time. However, for small interatomic distances, the van der Waals interaction between the Rydberg states can become very strong, and lead to an energy shift of the state |rr [symbol] , the state where both atoms are in the same Rydberg state, of magnitude V(R)=C₆/R⁶. If this interaction energy shift is larger than the laser coupling strength, such that V_{vdW}»hΩ, then the excitation of the doubly excited state is no longer possible. The suppression of more than a single excitation inside a certain radius is called the Rydberg blockade. The blockade radius R_{b} is the distance at which the interaction energy and the laser coupling strength are equal, such that R_{b}=(C₆/hΩ)^{1/6}. As the van der Waals interaction coefficient scales as C₆˜n¹¹, the blockade radius increases as n^{11/6} with the principal quantum number n, with typical values of R_{b} in a range of between 2 μm and 20 μm. The blockade radius decreases with increasing laser coupling strength (i.e., higher Rabi frequency Ω). As an additional or alternative control parameter, the interaction energy shift can also be increased by reducing the interatomic distance R, with the lower limit of R set by the optical resolution of the imaging system used to focus the optical tweezers, typically to about 2 μm.

Several implementations of optical excitation from an atomic ground state to a target Rydberg state are available. The simplest is direct laser excitation with a single-photon transition. The wavelengths for such transitions in Rydberg atoms are typically in the ultraviolet. For example, the single-photon wavelength for ⁸⁷Rb is 297 nm. Ultraviolet lasers pose serious experimental challenges, due to, for example, material degradation, and unavailability of optical fibers and low-loss optics. Alternatively, two-photon laser excitation can be used to couple the atomic ground state to a target Rydberg state through an intermediate electronic excited state by illuminating the atoms from opposite sides with two counterpropagating laser beams.

Consistent with the above description, the term “blockade” is used herein to refer to the phenomenon in which a laser-stimulated transition of an atom in a pair of interacting atoms from a first state (e.g., ground state) to an excited state cannot be achieved (is blockaded) due to a mismatch between the laser frequency and a shifted energy level of the excited state, where the shift in the energy level is electrically or magnetically induced. For example, a blockade can be achieved by a dipole-dipole interaction between two neighboring atoms where one is excited into a Rydberg state.

### Detuning From Resonance With an Excited State

The coherent evolution of two atoms under laser excitation from a ground state |g [symbol] to a Rydberg state |r [symbol] is described by the Hamiltonian

$$\frac{H}{ℏ} = \frac{Ω}{2} {\sum }_{i} ( \vert {g}_{i} {r}_{i} \vert + \vert {r}_{i} {g}_{i} \vert ) - Δ {\sum }_{i} {n}_{i} + {\sum }_{i < j} {V}_{ij} {n}_{i} {n}_{j} \qquad Equation 61$$

where Vᵢⱼ is the van der Waals interaction energy (V(R)=C₆/R⁶), nᵢ=|rᵢ [symbol] [symbol] rᵢ|, and Ω and Δ are the Rabi frequency and detuning of the laser excitation frequency away from the transition resonance frequency, respectively. For an interatomic distance R such that

$$\frac{{R}_{b}}{R} \approx 1 ,$$

sweeping the detuning Δ from negative to positive values while keeping the Rabi frequency Ω fixed implements the nearest-neighbor Rydberg blockade, where only one out of every pair of nearest-neighbor atoms can be excited to |r [symbol] .

Furthermore, in the two-photon laser excitation scheme, it is preferable to detune the two excitation lasers, that typically have one frequency in the blue range of the optical spectrum, such as 420 nm, and the other frequency in the red or infrared, such as 1013 nm, by a frequency shift δ away from the intermediate state (δ»Ω_{B}, Ω_{R}, where Ω_{B} and Ω_{R} are the Rabi frequencies of the blue and red lasers, respectively). This detuning avoids populating the intermediate state, thereby preventing spontaneous emission from this state, and enables the treatment of the time evolution of the population of atoms as a two-level system between |g [symbol] and |r [symbol] .

It will be appreciated that in various embodiments, the pulse sequences described herein may be generated by computer control of a laser source. Likewise, the detection of states as set out herein may be performed through various techniques known in the art and provided to a computer controller. Accordingly, it will be appreciated that in various embodiment computer instructions may be provided to perform said control and detection steps set out herein.

It will also be appreciated that a variety of methods may be used to read out the state of an array of atoms. For example, a quantum gas microscope may be used to determine whether each atom in an array is in an excited or ground state, as described in Browaeys, et al., Many-Body Physics with Individually-Controlled Rydberg Atoms, DOI: 10.1038/s41567-019-0733-z (available at https://arxiv.org/abs/2002.07413), which is hereby incorporated by reference in its entirety.

### Coherent Transport of Entangled Atoms

The apparatus described above may be used to provide coherent transport of neutral atoms while preserving quantum coherence and entanglement between qubits, by storing quantum information in hyperfine states and shuttling atoms in optical tweezers. This approach allows transport of atoms to and from multiple arrays, cavities, or other modules of an integrated quantum computing system.

For dynamic reconfiguration, mobile traps generated by a crossed 2D acousto-optic deflector (AOD) are utilized. This enables transport of atoms to and from static traps such as those generated by a spatial light modulator (SLM) and to and from other modules of a system.

The transport protocol is optimized to suppress heating and loss by implementing cubic-interpolated atom trajectories, and is further accompanied by an 8-pulse XY8 robust dynamical decoupling sequence to suppress dephasing. Fidelity remains unchanged until the total separation speed becomes >0.55 μm/μs, corresponding to the onset of atom loss.

More generally, entanglement is preserved when an atom is moved adiabatically. The term adiabatic movement refers to movement that avoids a transition of the subject atom within its trap. For example, where the first time-derivative of the acceleration of the subject atom is not greater than a predetermined value the movement is considered adiabatic.

Typically, adiabatic movement occurs when jerk<(size of atom)×(trap frequency)³.

Additional data regarding coherent transport is provided in Bluvstein, et al., A quantum processor based on coherent transport of entangled atom arrays, Nature 604, 451-456 (2022) (available at https://arxiv.org/abs/2112.03923), which is hereby incorporated by reference.

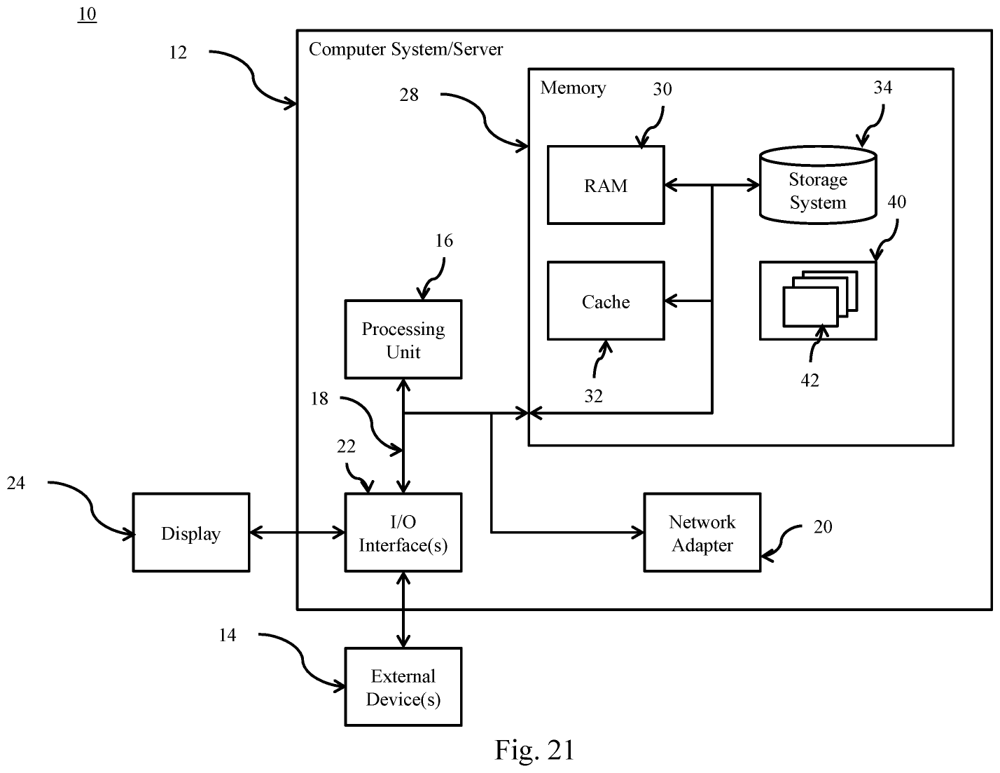

Referring now to FIG. 21, a schematic of an example of a computing node is shown. Computing node 10 is only one example of a suitable computing node and is not intended to suggest any limitation as to the scope of use or functionality of embodiments described herein. Regardless, computing node 10 is capable of being implemented and/or performing any of the functionality set forth hereinabove.

In computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 21, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

The present disclosure may be embodied as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Accordingly, in a 1^{st} example embodiment, the present invention is quantum computing system. In the 1^{st} aspect of the 1^{st} embodiment, the system comprises: a first array and a second array of neutral atoms, each array having a first dimensionality; each neutral atom having a first state and an excited Rydberg state, each neutral atom arranged to impose a Rydberg blockade on at least its nearest neighbors in its array when in the excited Rydberg state, thereby implementing a plurality of physical qubits; wherein each array comprises a plurality of data qubits, and a plurality of syndrome qubits, wherein, for each array, the plurality of syndrome qubits is configured to implement a quantum error correcting code with respect to the data qubits. The first array of neutral atoms comprises a first subarray of communication qubits, and the second array of neutral atoms comprises a second subarray of communication qubits, the first and second subarrays having a second dimensionality that is lower than the first dimensionality; each communication qubit of the first subarray array forming a Bell pair with one communication qubit of the second subarray; the first and second arrays of neutral atoms are configured to interact with each other only via the communication qubits.

In the 2^{nd} aspect of the 1^{st} embodiment, the first array of neutral atoms comprises a first edge, the second array of neutral atoms comprises a second edge, wherein: the first subarray of communication qubits is disposed at the first edge, and the second subarray of communication qubits is disposed at the second edge. The remainder of the features and the example features are as described above with respect to the 1^{st} aspect of the 1^{st} embodiment.

In the 3^{rd} aspect of the 1^{st} embodiment, for each array of neutral atoms, the plurality of syndrome qubits comprises a plurality of Z syndrome qubits and a plurality of X syndrome qubits configured to implement X and Z stabilizers with respect to the data qubits, thereby implementing the quantum error correcting code. The remainder of the features and the example features are as described above with respect to the 1^{st} or 2^{nd} aspects of the 1^{st} embodiment.

In the 4^{th} aspect of the 1^{st} embodiment, the system further comprises a connecting unit configured to create the Bell pair of a first and a second communication qubits, and to transport the first communication qubit to and/or from the first array and the second communication qubit to and/or from the second array. The remainder of the features and the example features are as described above with respect to any of the 1^{st} to 3^{rd} aspects of the 1^{st} embodiment.

In the 5^{th} aspect of the 1^{st} embodiment, the connecting unit comprises a first and a second resonant optical cavity in optical communication with each other, the first resonant optical cavity configured to accept a first neutral atom, the second resonant optical cavity configured to accept a second neutral atom, the first and second resonant optical cavities together configured to create the Bell pair from the first and the second neutral atoms. The remainder of the features and the example features are as described above with respect to any of the 1^{st} to 4^{th} aspects of the 1^{st} embodiment.

In the 6^{th} aspect of the 1^{st} embodiment, the connecting unit comprises a first and a second auxiliary arrays of neutral atoms, and a first and a second avalanche photodiode (APD) arrays in optical communication with the first and second auxiliary arrays of neutral atoms and with each other, the first and the second APD arrays together configured to create the Bell pair from the first and the second auxiliary arrays of neutral atoms. The remainder of the features and the example features are as described above with respect to any of the 1^{st} to 5^{th} aspects of the 1^{st} embodiment.

In the 7^{th} aspect of the 1^{st} embodiment, each of the first and second arrays of neutral atoms is two-dimensional. The remainder of the features and the example features are as described above with respect to any of the 1^{st} to 6^{th} aspects of the 1^{st} embodiment.

In the 8^{th} aspect of the 1^{st} embodiment, the quantum error correcting code is a topological code, a stabilizer code, or a surface code. The remainder of the features and the example features are as described above with respect to any of the 1^{st} to 7^{th} aspects of the 1^{st} embodiment.

In the 9^{th} aspect of the 1^{st} embodiment, each of the first and second arrays comprise: a plurality of data qubits such that each data qubit in the plurality is a nearest neighbor to two Z syndrome qubits and to two X syndrome qubits; and a plurality of measurement qubits such that each syndrome qubit in the plurality is a nearest neighbor to four data qubits. The remainder of the features and the example features are as described above with respect to any of the 1^{st} to 8^{th} aspects of the 1^{st} embodiment.

In the 10^{th} aspect of the 1^{st} embodiment, the system further comprises at least one confinement system for arranging neutral atoms in an array, wherein each neutral atom is disposed at a vertex of a lattice, and each neutral atom, when in the excited Rydberg state, has a Rydberg blockade radius sufficient to blockade each of at least four nearest neighboring neutral atoms in the lattice. The at least one confinement system comprises laser source arranged to create a plurality of confinement regions; a source of a neutral atom cloud, the neutral atom cloud configured to be positioned to at least partially overlap with the plurality of confinement regions; and an excitation source for exciting at least some of the neutral atoms from the first state to the excited Rydberg state. The remainder of the features and the example features are as described above with respect to any of the 1^{st} to 9^{th} aspects of the 1^{st} embodiment.

In the 11^{th} aspect of the 1^{st} embodiment, lattice is a rectilinear lattice. The remainder of the features and the example features are as described above with respect to any of the 1^{st} to 10^{th} aspects of the 1^{st} embodiment.

In the 12^{th} aspect of the 1^{st} embodiment, neutral atoms are selected from ⁸⁷Rb atoms, ¹³³Cs atoms, ⁸⁵Rb atoms, ¹⁷¹Yb atoms, ¹⁷⁴Yb atoms, ⁸⁸Sr atoms, ⁸⁷Sr atoms, ⁸⁴Sr atoms, ⁸⁶Sr atoms, ³⁹K atoms, ⁴⁰K atoms, ⁴¹K atoms, ²³Na atoms, ⁶Li atoms, and ⁷Li atoms. The remainder of the features and the example features are as described above with respect to any of the 1^{st} to 11^{th} aspects of the 1^{st} embodiment.

In the 13^{th} aspect of the 1^{st} embodiment, 13 the plurality of data qubits has a CNOT error (p_{CNOT}) not exceeding 0.01. The remainder of the features and the example features are as described above with respect to any of the 1^{st} to 12^{th} aspects of the 1^{st} embodiment.

In the 14^{th} aspect of the 1^{st} embodiment, the Bell pair has an error (p_{Bell}) not exceeding 0.1. The remainder of the features and the example features are as described above with respect to any of the 1^{st} to 13^{th} aspects of the 1^{st} embodiment.

In a 2^{nd} example embodiment, the present invention is a method of carrying out a logical operation between logical qubits. In a 1^{st} aspect of the 2^{nd} embodiment, the method comprises: providing a quantum computing system as described above with respect to any one of the 1^{st} to 14^{th} aspects of the 1^{st} embodiment; and carrying out a logical operation between at least one data qubit of the first array and at least one data qubit of the second array.

In a 3^{rd} example embodiment, the present invention is a method of extending a quantum error correcting code across two non-interacting arrays of particles. In a 1^{st} aspect of the 3^{rd} embodiment, the method comprises: as described above with respect to any of the 1^{st} to 14^{th} aspects of the 1^{st} embodiment; and extending the quantum error correcting code across the first and second arrays.

In the 2^{nd} aspect of the 2^{nd} or the 3^{rd} embodiments, the method further comprises creating a Bell pair of a third and fourth communication qubits; and transporting the third communication qubit to the first array and the fourth communication qubit to and/or from the second array. The remainder of the features and the example features are as described above with respect to the 1^{st} aspect of the 2^{nd} or 3^{rd} embodiments.

In the 3^{rd} aspect of the 2^{nd} or the 3^{rd} embodiments, wherein implementing the quantum error correcting code comprises dividing the plurality of syndrome qubits into a plurality of subsets; for each of the plurality of subsets, measuring the syndrome qubits therein simultaneously. The remainder of the features and the example features are as described above with respect to the 1^{st} or 2^{nd} aspects of the 2^{nd} or 3^{rd} embodiments.

In the 4^{th} aspect of the 2^{nd} or the 3^{rd} embodiments, wherein implementing the quantum error correcting code further comprises sequentially moving each of the plurality of subsets of syndrome qubits into an optical cavity for said measuring. The remainder of the features and the example features are as described above with respect to the 1^{st} to 3^{rd} aspects of any of the 2^{nd} or 3^{rd} embodiments.

In the 5^{th} aspect of the 2^{nd} or the 3^{rd} embodiments, measuring the syndrome qubits in each of the plurality of subsets comprises placing the syndrome qubits not in the subset being measured into a shelf state prior to measuring. The remainder of the features and the example features are as described above with respect to any of the 1^{st} to 4^{th} aspects of the 2^{nd} or 3^{rd} embodiments.

In the 6^{th} aspect of the 2^{nd} or the 3^{rd} embodiments, implementing the quantum error correcting code comprises identifying one or more syndrome qubit in an error state by incrementally measuring and dividing the plurality of syndrome qubits into said subsets. The remainder of the features and the example features are as described above with respect to any of the 1^{st} to 5^{th} aspects of the 2^{nd} or 3^{rd} embodiments.

In the 7^{th} aspect of the 2^{nd} or the 3^{rd} embodiments, the plurality of data qubits has a CNOT error (p_{CNOT}) not exceeding 0.01. The remainder of the features and the example features are as described above with respect to any of the 1^{st} to 6^{th} aspects of the 2^{nd} or 3^{rd} embodiments.

In the 8^{th} aspect of the 2^{nd} or the 3^{rd} embodiments, the Bell pair has an error (p_{Beu}) not exceeding 0.1. The remainder of the features and the example features are as described above with respect to any of the 1^{st} to 7^{th} aspects of the 2^{nd} or 3^{rd} embodiments.

In a 4^{th} example embodiment, the present inventions is a method of implementing a quantum error correcting code, comprising: forming a plurality of Bell pairs of neutral atoms, each neutral atom having a first state and an excited Rydberg state, each of the plurality of Bell pairs comprising a first communication qubit and a second communication qubit; transporting each of the first communication qubits of the plurality of Bell pairs to a first array of neutral atoms, comprising a first plurality of syndrome qubits and a first plurality of data qubits; transporting each of the second communication qubits of the plurality of Bell pairs to a second array of neutral atoms, comprising a second plurality of syndrome qubits and a second plurality of data qubits; performing at least one Rydberg gate between the first or second plurality of syndrome qubits and the first or second plurality of data qubits; transporting the first and/or second plurality of syndrome qubits to an optical cavity; driving the optical cavity with a coherent light source; measuring a transmissivity through the optical cavity, thereby detecting the presence or absence of an error in the first and/or second plurality of syndrome qubits; returning the first and/or second plurality of syndrome qubits to their respective array of neutral atoms.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A quantum computing system comprising:
a first array and a second array of neutral atoms, each array having a first dimensionality;
each neutral atom having a first state and an excited Rydberg state,
each neutral atom arranged to impose a Rydberg blockade on at least its nearest neighbors in its array when in the excited Rydberg state, thereby implementing a plurality of physical qubits;
wherein each array comprises a plurality of data qubits, and a plurality of syndrome qubits, wherein, for each array, the plurality of syndrome qubits is configured to implement a quantum error correcting code with respect to the data qubits;
and further wherein:
the first array of neutral atoms comprises a first subarray of communication qubits, and the second array of neutral atoms comprises a second subarray of communication qubits, the first and second subarrays having a second dimensionality that is lower than the first dimensionality;
each communication qubit of the first subarray array forming a Bell pair with one communication qubit of the second subarray;
the first and second arrays of neutral atoms are configured to interact with each other only via the communication qubits.

2. The system of claim 1, wherein the first array of neutral atoms comprises a first edge, the second array of neutral atoms comprises a second edge, and wherein:
the first subarray of communication qubits is disposed at the first edge, and
the second subarray of communication qubits is disposed at the second edge.

3. The system of any one of claims 1-2, wherein, for each array of neutral atoms, the plurality of syndrome qubits comprises a plurality of Z syndrome qubits and a plurality of X syndrome qubits configured to implement X and Z stabilizers with respect to the data qubits, thereby implementing the quantum error correcting code.

4. The system of any one of claims 1-3, further comprising:
a connecting unit configured to create the Bell pair of a first and a second communication qubits, and to transport the first communication qubit to and/or from the first array and the second communication qubit to and/or from the second array.

5. The system of claim 4, wherein the connecting unit comprises a first and a second resonant optical cavity in optical communication with each other, the first resonant optical cavity configured to accept a first neutral atom, the second resonant optical cavity configured to accept a second neutral atom, the first and second resonant optical cavities together configured to create the Bell pair from the first and the second neutral atoms.

6. The system of claim 4, wherein the connecting unit comprises a first and a second auxiliary arrays of neutral atoms, and a first and a second avalanche photodiode (APD) arrays in optical communication with the first and second auxiliary arrays of neutral atoms and with each other, the first and the second APD arrays together configured to create the Bell pair from the first and the second auxiliary arrays of neutral atoms.

7. The system of any one of claims 1-6, wherein each of the first and second arrays of neutral atoms is two-dimensional.

8. The system of any one of claims 1-7, wherein the quantum error correcting is a topological code, a stabilizer code, or a surface code.

9. The system of claim 8, wherein each of the first and second arrays comprise:
a plurality of data qubits such that each data qubit in the plurality is a nearest neighbor to two Z syndrome qubits and to two X syndrome qubits; and
a plurality of measurement qubits such that each syndrome qubit in the plurality is a nearest neighbor to four data qubits.

10. The system of any one of claims 1-9, further comprising:
at least one confinement system for arranging neutral atoms in an array, wherein each neutral atom is disposed at a vertex of a lattice, and each neutral atom, when in the excited Rydberg state, has a Rydberg blockade radius sufficient to blockade each of at least four nearest neighboring neutral atoms in the lattice;
the at least one confinement system comprising:
a laser source arranged to create a plurality of confinement regions;
a source of a neutral atom cloud, the neutral atom cloud configured to be positioned to at least partially overlap with the plurality of confinement regions; and
an excitation source for exciting at least some of the neutral atoms from the first state to the excited Rydberg state.

11. The system of claim 10, wherein the lattice is a rectilinear lattice.

12. The system of any one of claims 1-11, wherein neutral atoms are selected from ⁸⁷Rb atoms, ¹³³Cs atoms, ⁸⁵Rb atoms, ¹⁷¹Yb atoms, ¹⁷⁴Yb atoms, ⁸⁸Sr atoms, ⁸⁷Sr atoms, ⁸⁴Sr atoms, ⁸⁶Sr atoms, ³⁹K atoms, ⁴⁰K atoms, ⁴¹K atoms, ²³Na atoms, ⁶Li atoms, and ⁷Li atoms.

13. The system of any one of claims 1-12, wherein the plurality of data qubits has a CNOT error (p_{CNOT}) not exceeding 0.01.

14. The system of any one of claims 1-13, wherein the Bell pair has an error (p_{Bell}) not exceeding 0.1.

15. A method of carrying out a logical operation between logical qubits, the method comprising:
providing a quantum computing system comprising:
a first array and a second array of neutral atoms, each array having a first dimensionality;
each neutral atom having a first state and an excited Rydberg state, each neutral atom arranged to impose a Rydberg blockade on at least its nearest neighbors in its array when in the excited Rydberg state, thereby implementing a plurality of physical qubits;
wherein each array comprises a plurality of data qubits, and a plurality of syndrome qubits, wherein, for each array, the plurality of syndrome qubits is configured to implement a quantum error correcting code with respect to the data qubits;
and further wherein:
the first array of neutral atoms comprises a first subarray of communication qubits, and the second array of neutral atoms comprises a second subarray of communication qubits, the first and second subarrays having a second dimensionality that is lower than the first dimensionality;
each communication qubit of the first subarray array forming a Bell pair with one communication qubit of the second subarray, thereby extending the quantum error correcting code across the first and second arrays;
the first and second arrays of neutral atoms are configured to interact with each other only via the communication qubits; and
carrying out a logical operation between at least one data qubit of the first array and at least one data qubit of the second array.

16. A method of extending a quantum error correcting code across two non-interacting arrays of particles, the method comprising:
providing a quantum computing system comprising:
a first array and a second array of neutral atoms, each array having a first dimensionality;
each neutral atom having a first state and an excited Rydberg state,
each neutral atom arranged to impose a Rydberg blockade on at least its nearest neighbors in its array when in the excited Rydberg state, thereby implementing a plurality of physical qubits;
wherein each array comprises a plurality of data qubits, and a plurality of syndrome qubits, wherein, for each array, the plurality of syndrome qubits is configured to implement a quantum error correcting code with respect to the data qubits;
and further wherein:
the first array of neutral atoms comprises a first subarray of communication qubits, and the second array of neutral atoms comprises a second subarray of communication qubits, the first and second subarrays having a second dimensionality that is lower than the first dimensionality;
each communication qubit of the first subarray array forming a Bell pair with one communication qubit of the second subarray, thereby extending the quantum error correcting code across the first and second arrays;
the first and second arrays of neutral atoms are configured to interact with each other only via the communication qubits; and
extending the quantum error correcting code across the first and second arrays.

17. The method of claim 15 or claim 16, wherein the first array of neutral atoms comprises a first edge, the second array of neutral atoms comprises a second edge, and wherein:
the first subarray of communication qubits is disposed at the first edge, and the second subarray of communication qubits is disposed at the second edge.

18. The method of any one of claims 15-17 wherein, for each array of neutral atoms, the plurality of syndrome qubits comprises a plurality of Z syndrome qubits and a plurality of X syndrome qubits configured to implement X and Z stabilizers with respect to the data qubits, thereby implementing the quantum error correcting code.

19. The method of any one of claims 15-18, further comprising:
creating a Bell pair of a third and fourth communication qubits; and
transporting the third communication qubit to the first array and the fourth communication qubit to and/or from the second array.

20. The method of any one of claims 15-19, wherein implementing the quantum error correcting code comprises:
dividing the plurality of syndrome qubits into a plurality of subsets;
for each of the plurality of subsets, measuring the syndrome qubits.

21. The method of claim 20, wherein for each of the plurality of subsets, the syndrome qubits are measured simultaneously.

22. The method of claim 20, wherein implementing the quantum error correcting code further comprises:
sequentially moving each of the plurality of subsets of syndrome qubits into an optical cavity for said measuring.

23. The method of claim 20, wherein measuring the syndrome qubits in each of the plurality of subsets comprises:
placing the syndrome qubits not in the subset being measured into a shelf state prior to measuring.

24. The method of any one of claims 20-23, wherein implementing the quantum error correcting code comprises identifying one or more syndrome qubit in an error state by incrementally measuring and dividing the plurality of syndrome qubits into said subsets.

25. The method of any one of claims 15-24, wherein the plurality of data qubits has a CNOT error (P_{CNOT}) not exceeding 0.01.

26. The method of any one of claims 15-25, wherein the Bell pair has an error (p_{Bell}) not exceeding 0.1.

27. A method of implementing a quantum error correcting code, comprising:
forming a plurality of Bell pairs of neutral atoms, each neutral atom having a first state and an excited Rydberg state, each of the plurality of Bell pairs comprising a first communication qubit and a second communication qubit;
transporting each of the first communication qubits of the plurality of Bell pairs to a first array of neutral atoms, comprising a first plurality of syndrome qubits and a first plurality of data qubits;
transporting each of the second communication qubits of the plurality of Bell pairs to a second array of neutral atoms, comprising a second plurality of syndrome qubits and a second plurality of data qubits;
performing at least one Rydberg gate between the first or second plurality of syndrome qubits and the first or second plurality of data qubits;
transporting the first and/or second plurality of syndrome qubits to an optical cavity;
driving the optical cavity with a coherent light source;
measuring a transmissivity through the optical cavity, thereby detecting the presence or absence of an error in the first and/or second plurality of syndrome qubits;
returning the first and/or second plurality of syndrome qubits to their respective array of neutral atoms.
